(19) United States
(12) Patent Application Publication
(10) Pub. No.: US 2006/0257785 A1
(43) Pub. Date: Nov. 16, 2006

(54) Method of forming a photoresist element

(76) Inventor: Donald W. Johnson, Wayland, MA (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/432,099

(22) Filed: May 11, 2006

Related U.S. Application Data
(60) Provisional application No. 60/680,801, filed on May 13, 2005.

(51) Int. Cl. G03C 1/00

(52) U.S. Cl. 430/270.1

(57) ABSTRACT

A method of forming a photoresist element comprising the steps of: preparing a hot melt photoresist mixture; applying the photoimageable hot melt composition to a film substrate using a slot die coating system; cooling the hot melt sufficiently to prevent flow; and applying a protective cover film to the opposite surface of the partially cooled composition, thereby forming a photoresist element.

### CROSS-REFERENCE TO RELATED APPLICATIONS

This application claims the benefit of U.S. Provisional Patent Application No. 60/680,801 filed May 13, 2005.

### BACKGROUND OF THE INVENTION

1. Field of the Invention

This invention relates to a method of forming a photoresist element using a slot die coating system. The present invention also relates to composite articles of manufacture made using the photoresist element.

2. Brief Description of Art

Photoimageable coatings (commonly known as photoresists) are currently used in a wide variety of semiconductor and micromachining applications. In such applications, photoimaging is accomplished by exposing a photosensitive coating on a substrate to patterned radiation thereby inducing a solubility change in the coating such that the exposed or unexposed regions can be selectively removed by treatment with a suitable developer composition. The photoimageable coating or photoresist may be either of the positive or negative type, where exposure to radiation either respectively increases or decreases the solubility in the developer.

The most common photoimageable coatings useful in microelectronic applications are liquid compositions comprising a film forming resin, a photoactive compound, and a solvent. These compositions may be applied to a substrate either directly in liquid form and then dried to form a coating on the substrate or they may be first formed into a composite film comprising a substantially dried coating of the liquid photoresist on a polymer film such that when the coated side of the composite film is contacted with the substrate under the action of heat and pressure, the photoimageable coating is adhered to the substrate and the polymer film is then removed leaving the photosensitive layer on the substrate. Photoimageable composite films of the type described are commonly referred to in the art as dry film photoresists or photoresist elements. The term “photoresist element” is a photoimageable composition applied between the substrate polymer film or foil and a protective polymeric cover sheet. Depending on the application, such dry film photoresists (or photoresist elements) may offer advantages over liquid photoresists particularly for thick films where they provide much higher throughput, coating uniformity, and lower cost application methods. Dry film photoresists are especially useful when the coated substrate is of irregular shape (not round), the substrate is not compatible with the solvents present in the liquid photoresist or when the substrate, for either for technical or economic reasons, cannot be baked under the conditions of time and temperature necessary to remove the solvent. Generally, dry film photoresist compositions have been made from a liquid photoimagable composition which is coated onto a first substrate using one of several conventional coating techniques. A substantial portion of the solvent in the liquid photoimagable composition is removed by heating or other suitable processing to form a dry photoresist layer on the first substrate. This process is typically limited to single coating thicknesses of 100 μm or less. Later, the dry film photoresist is imaged and developed according to conventional processing, either on this first substrate or after being transferred onto a second substrate. These imaged and dry films can be then removed from that substrate by conventional stripping or photoresist removal processing (in which case this photoresist layer is a temporary photoresist) or hardened and caused to become part of the end use application (in which case this photoresist layer is a permanent photoresist).

There have been many prior art proposals for different photoimageable compositions. Many of those formulations include epoxy compounds. For example, see U.S. Pat. No. 5,264,325. In that patent, it is further taught that the photoresist material must be formulated such that it can be applied by coating methods, for example spin coating or die coating, which require certain rheological properties. In addition, the composition must have the properties of providing sufficient transmission of the exposing radiation so as to photolyze the photoinitiator through the thickness of the film, and it must produce virtually blemish-free coatings containing virtually no particulate materials or defects. The photoresist must possess appropriate physical and chemical properties to withstand the application, such as solder or ink resistance or toughness, without significant degradation, or loss of adhesion. If the photoresist is to be used for other purposes, such as an etch photoresist, other properties may be required.

Separately, numerous U.S. patents and other references teach the preparation and use of dry film photoresists. These references include U.S. Pat. Nos. 3,496,982, 3,526,504, 3,547,730, 4,193,797, 4,193,799, 4,260,675, 4,624,912, 5,077,174, and 6,204,456. Most of the references prepare the photoresist element by coating a solution of a photosensitive composition in an organic solvent using various coatings methods. U.S. Pat. No. 6,060,215 expressly describes the solution slot die coating of a photosensitive resin composition onto a polyethylene terephthalate substrate film, and this method is prevalent in the preparation of many modern photoresist elements.

Negative photoresists based on the above disclosed compositions which are suitable for spin-coating are sold by MicroChem Corp., Newton, Mass., USA and are used commercially, especially in the fabrication of MEMS devices. For example, a product typically offered by MicroChem, “SU-8 50” can be spin-coated at 1000-3000 rpm to produce films of thickness in the range of 30-100 microns, which after exposure and development; can produce images having an aspect ratio greater than 10:1 at film thicknesses greater than 100 microns. Higher or lower solids versions extend the film thickness range obtainable by a single coat process to less than 1 micron and above 200 microns. Casting of the solution can result in films of 1 to 2 millimeters or more in thickness. U.S. Pat. No. 4,882,245 describes the application of such materials as a dry film photoresist when coated onto a carrier medium such as Mylar film. U.S. patent application Ser. No. 10/945,334 and an article by Kieninger, et. al. (Proceedings μTAS 2004, Malmo, p363 (2004)) describe other similar dry film materials. U.S. Published Patent Application No. 2004/0233261 describes the preparation of an SU-8 element on Mylar by spin coating a liquid solution of the composition onto a Mylar disc and subsequent lamination onto a structured silicon wafer.

U.S. Pat. Nos. 4,882,245 and 4,940,651 disclose a photoimageable, cationically-polymerizable composition for use in printed circuit boards which consists of a mixture of up to 88% epoxidized bisphenol A formaldehyde novolac resin with average epoxide functionality of eight and a reactive diluent which serves as a plasticizer, and a cationic photoinitiator. Reactive diluents disclosed were either mono- or di-functional cycloaliphatic epoxides, preferably at 10-35% by weight solids. Also disclosed are the use of these formulations as permanent layers, where the layer is not removed from the substrate, but becomes a part of the structure, such as a dielectric layer on a printed circuit board. Such a formulation may also be used to form a photosensitive element.

U.S. Pat. Nos. 5,026,624, 5,278,010, and 5,304,457 disclose a photoimageable, cationically polymerizable fire retardant composition suitable for use as a solder mask, which consists of a mixture of the 10-80% by weight condensation product of bisphenol A and epichlorohydrin, 20-90% by weight of epoxidized bisphenol A formaldehyde novolac resin, and 35-50% by weight of the glycidyl ether of tetrabromobisphenol A, with 0.1-15 parts per hundred by weight of a cationic photoinitiator. Curtain coating, roll coating, and wound wire rod coating were used as methods of coating. This composition could also be made into a dry film photoresist.

Other methods of coating photosensitive compositions onto various substrates have also been described. For instance Chen, U.S. Pat. No. 4,323,637, describes an extrusion process for manufacturing of a photosensitive element useful for printing plates. Here 100% solids, elastomeric block copolymer compositions are hot melted in a screw extruder and extruded through a sheet die onto a cooled casting wheel to generate, a free standing sheet of the cooled melt. This is then interposed between a substrate film and a protective coversheet film and hot pressed on a platen press or calendar roll to form photosensitive layers from about 0.012 to about 6 millimeters in thickness. Similarly Goss, U.S. Pat. No. 5,735,983, describes the extrusion of a photocurable polymer onto a moving carrier to achieve self lamination for flexographic printing plates in a nip-free manner. Here the components are melted in a screw extruder, metered to a sheet die and then self-laminated onto the moving carrier web. After cooling one or more grinding steps are employed to ensure a uniform thickness in the polymer sheet. Thicknesses of 0.5 to 7.5 millimeters can be obtained. In both of these cases the photosensitive or photocurable composition is first extruded into a free standing sheet and then applied to a substrate film and the quality of the extruded film surface is not critical as it can be further processed to obtain an acceptable quality surface. Further, Bentley, U.S. Pat. No. 5,720,820, describes a machine for slot die coating intermittent films using a stream of air to carry the film to the article being coated.

Nakamura, U.S. Pat. No. 5,633,042, describes a process of slot die coating a temperature-sensitive epoxy melt containing a hardener onto a glass cloth and forming a prepreg component for use as an electrically insulating material by further melting the coating into the glass cloth. The two components need to be separately filtered and metered, quickly mixed and then coated under specific temperature, average residence time and low shear conditions. The quality of the coated film surface is unimportant and the warm prepreg material is actually pressed between two plates or a compaction roller to obtain a flat, smooth surface.

Enlow, in a series of U.S. patents (U.S. Pat. Nos. 6,254,712, 6,336,988, 6,547,912, and 6,773,804), describes solventless extrusion die coating to form an optically clear coating to produce defect-free elements for protective and decorative films such as for use in automotive coatings, exterior siding, and optically clear polymer films. Again a single screw extruder is used to feed the melt to the extrusion die, forming a film which is cast onto the traveling flexible carrier sheet. These blended fluoropolymer/acrylic polymer films are quite temperature stable and do not contain any photosensitive components. Typical thicknesses range from about 25 to 75 μm (0.025 to 0.075 millimeters).

While photoresist elements are quite frequently described in the literature, they are not without their problems. One such problem is the adhesion of the coated film to the substrate film as described in Mimura, U.S. Pat. No. 6,368,722. Therefore it is frequently necessary to precoat the substrate film with a release layer of a different chemical composition in order to be able to uniformly coat the substrate film and then to easily remove the coversheet and the substrate film from the photosensitive coating such as described in the Mimura patent and by Taylor in U.S. Pat. No. 6,001,532. Enlow, U.S. Pat. No. 6,254,712, describes the difficulty of extruding polymeric materials into highly transparent, essentially defect-free thin film layers and notes that extrusion techniques have not been successfully adapted to producing high optical quality films at high line speeds and at low cost.

Another widely used method of applying photosensitive coatings is slot die coating, where either liquid cast solutions are coated as described above for photosensitive elements or where 100% solids, hot melt compositions are slot die coated directly onto a moving substrate. The latter method is widely used to coat such diverse items as moisture permeable diaper liners, U.S. Published Patent Application No. 2002/0019187, multiple layer diffusion films for display applications, U.S. Pat. No. 6,636,363, adhesive tape, U.S. Pat. No. 5,738,939, and sanding belts, U.S. Pat. No. 5,565,011.

Slot coating is a workhorse process of the adhesives industry. In the slot coating process, a slotted die, which is connected to a supply of coating fluid, is positioned in close proximity to a moving substrate which is known in the art as the coating web or simply the web. The coating fluid is deposited through the die onto the substrate to produce a continuous and uniform thin liquid coating on the web. The hot melt slot die coat process is widely used to coat adhesives on a wide variety of substrates including photocurable epoxy compositions. One such demonstrative application is shown by Follett in U.S. Pat. No. 5,565,011, wherein a make-coat layer of a photocurable, hot melt coatable, pressure sensitive adhesive composition is slot die coated onto a PET film. The make-coat layer is then applied to appropriate backing materials via lamination that would normally present processing problems. The make-coat is then used in the manufacture of abrasive articles such as sanding belts. The preferred composition comprises an epoxy-containing material, a polyester component and an effective amount of a photo initiator. It should be noted that while the composition is photocurable it is not photoimageable to the extent required for dry film photoresist compositions. Also, the coating quality of such adhesive films is not to the level required for photoresist elements.

While these numerous references teach various photoresist formulations and methods for preparing dry film materials, there is still a need for better methods to prepare modern dry film formulations. The present invention offers a solution to that need by providing a versatile, low cost method for preparing dry film materials for those modern day film applications. The present invention provides a hot melt, slot die coat process that is an alternative to solution cast or extruded coating techniques. Uniform films of only a few microns thick to greater than several millimeters can be prepared in this process using a single piece of equipment and only changing the coating speed and the coating rate. Use of the techniques of this invention provide the advantages of avoiding expensive solvents, producing no VOC emissions, and avoiding cross-contamination associated with solvent casting. The process according to the invention has the further advantages of increased line speed, elimination of steps in the manufacturing process, great versatility in changing coating thicknesses, and reducing overall costs for the coating process.

### SUMMARY OF THE INVENTION

This invention relates to the preparation of a photoresist element and composite articles of dry film photoresist made using those photoresist elements. Such articles are useful for the fabrication of electronic components, micro-electromechanical system (MEMS) components, micromachine components, microfluidic components, bioMEMS components, micro total analysis system (μ-TAS) components, medical devices, micro optical or waveguide components, microreactor components, electroconductive layers, lithographic galvanoformung abformung (LIGA) components, displays, forms and stamps for microinjection molding and microembossing, screens or stencils for fine printing applications, MEMS and IC packaging (passivation or stress/buffer coats, die attach and no-flow underfills, and the like), wafer level packaging (wafer bonding, chip stacking, 3-D interconnects and the like), integrated passives and printed wiring boards (high density interconnects, solder masks, inner layers, and the like) that can be processed by ultraviolet (UV), x-ray or electron beam lithography. Suitable electronic component applications include dielectric layers, insulation layers, wafer bonding layers and photoconductive wave circuits. Optical applications can include, optical interconnects, waveguides, optical switches, spacers, optical displays, flexible OLEDs, backplanes, diffuser or reflector elements or protective coatings for optical, LED or OLED components. Other uses include as resin or polymer substrates for other photoimageable layers or as films for UV or hot embossing of patterned structures such as for nano-imprint lithography or large area display applications and in the construction of structures for the separation, analysis, and preparation of arrays for biochemical analysis and in the construction of cell growth platforms for biological materials. Still other suitable applications may include the use as cover sheets in the fabrication of buried channel and air-bridge structures used, for example, in microfluidic or optical devices or for the reservoir, fluidic channels or nozzle layer of ink jet heads.

Therefore, one aspect of the present invention is directed to a method of forming a photoresist element comprising the steps of: (1) preparing a hot melt photoresist composition; (2) applying the hot melt photoresist composition to a substrate using a slot die coating system; (3) cooling the hot melt sufficiently to prevent flow; and (4) applying a protective cover sheet to the opposite surface of the partially cooled composition, thereby forming a photoresist element.

Still another aspect of the present invention is directed to a method of forming a permanent photoresist pattern using the photoresist element as formed by the steps above and further comprising the process steps of: (1) optionally, removing the substrate film or the protective cover sheet from the photoresist element, leaving a layer of the photoresist element attached to the substrate or coversheet or both; (2) optionally, laminating the layer of photoresist element to a second substrate; (3) optionally removing the film substrate from the laminated layer of the photoresist element on the second substrate; (4) imagewise irradiating the photoresist element layer with actinic radiation; (5) removing at least one of the film substrates, the second substrate or the protective cover sheet, if not already removed from the photoresist element layer; (6) crosslinking the irradiated areas of the layer of photoresist element by heating; (6) optionally, developing an image in the layer of the photoresist element with a developer solution, thereby forming a relief image in the photoresist element layer or repeating the process from step (1) with an additional photoresist element; and (7) optionally hardening the developed relief image by heating.

### DETAILED DESCRIPTION OF THE INVENTION

Description of the Photoimageable Coating Composition

The term “solvent free” as used in the present specification and claims means a composition containing less than 5% by weight of solvent, preferably less than 1% by weight of solvent, and most preferably, containing essentially no solvent or volatile component.

The photoimageable coating composition of the present invention is comprised of: (A) at least one polyfunctional resin; and (B) at least one photoacid generator or other thermally stable photosensitive material.

Polyfunctional resins which are applicable include a wide range of reactive materials such vinyl ethers, silicones, polyurethanes, formals, acetals, t-butyl esters, t-butoxycarbonylesters. In one preferred embodiment, the polyfunctional resin is a fully or partially epoxidized novolac resin or cycloaliphatic resin or mixtures thereof. More preferably, the polyfunctional resin (A) is a fully or partially epoxidized polyfunctional novolac or cycloaliphatic resin having an epoxide equivalent weight of about 150 to 500 grams/equivalent. Most preferably, the polyfunctional resin is an epoxidized octafunctional bisphenol A novolac resin having an epoxide equivalent weight of about 195 to 230 gram/eq. Also most preferable the polyfunctional resin is a mixture of two or more polyfunctional resins. Other preferred polyfunctional resins are mentioned in the Examples below.

The term “multifunctional” as used herein means any resin material having more than one chemical moiety that is reactive with the acid or base or other photosensitive materia which is formed when the composition is exposed to actinic radiation and when optionally subsequently heated. Such reactions which are initiated by the photogenerated acid or base include a wide variety of systems where the reactive species is reactive with the other constituents in the composition itself or between different reactive moieties in these multifunctional resins themselves.

Bisphenol A novolac epoxy resins are particularly suitable for use in the present invention and can be obtained by reacting a bisphenol A novolac resin and epichlorohydrin. Resins having a weight average molecular weight ranging from 4000 to 7000 are particularly preferred. Epicoat® 157 (epoxide equivalent weight of 180 to 250 grams resin per equivalent of epoxide (g resin/eq or g/eq) and a softening point of 80-90° C.) made by Resolution Performance Products, Houston, Tex. and the like are cited as preferred examples of bisphenol A novolac epoxy resins suitable for use in the present invention. Examples of additional epoxy resins suitable for use are NC-3000H Resin and NER-7604 Resin, both available from Nippon Kayaku Co., Ltd. of Tokyo, Japan. These optional epoxy resins may be used in amounts of more than 50% by weight of Resin A. Phenol-novolac epoxy resins, trisphenolmethane epoxy resins, and the like are cited as examples of other alternate epoxy resins. Polyfunctional resins may be used to impart further properties to the composition such as flame retardancy and include epoxidized tetrabromobisphenol A formaldehyde novolak resins such as DER 542 from Dow Chemical or polymeric phosphorus derivatives.

A variety of polyfunctional cycloaliphatic epoxy resins may also be used alone or in combination with the above resins. These include resins such as 3,4-epoxycyclohexyl 3′-4′-epoxycyclohexane carboxylate available from Dow Chemical as ERL 4221E or Huntsmann as Araddite CY 179, bis(3,4-epoxycyclohexyl) adipate available from Dow Chemical as ERL 4299, dicyclopentadiene diepoxide, 4-vinylcyclohexene diepoxide and limonene diepoxide among others. Among these 3,4-epoxycyclohexyl 3′-4′-epoxycyclohexane carboxylate, bis(3,4-epoxycyclohexyl) adipate and dicyclopentadiene diepoxide are the preferred cycloaliphatic epoxy resins.

Compounds that generate a protic acid when irradiated by active rays, such as ultraviolet rays, and the like, are preferred as the photoacid generator (B) used in the present invention. Aromatic iodonium complex salts and aromatic sulfonium complex salts are cited as examples. Di-(t-butylphenyl)iodonium triflate, diphenyliodonium tetrakis(pentafluorophenyl)borate, diphenyliodonium hexafluorophosphate, diphenyliodonium hexafluoroantimonate, di(4-nonylphenyl)iodonium hexafluorophosphate, [4-(octyloxy)phenyl]phenyliodonium hexafluoroantimonate, and the like are cited as specific examples of the aromatic iodonium complex salts that can be used. Moreover, triphenylsulfonium triflate, triphenylsulfonium hexafluorophosphate, triphenylsulfonium hexafluoroantimonate, triphenylsulfonium tetrakis(pentafluorophenyl)borate, 4,4′-bis[diphenylsulfonium]diphenylsulfide, bis-hexafluorophosphate, 4,4′-bis[di(β-hydroxyethoxy)phenylsulfonium]diphenylsulfide bis-hexafluoroantimonate, 4,4′-bis[di(β-hydroxyethoxy)phenylsulfonium)diphenyl sulfide-bis-hexafluorophosphate 7-[di(p-tolyl)sulfonium]-2-isopropylthioxanthone hexafluorophosphate, 7-[di(p-tolyl)sulfonio-2-isopropylthioxanthone hexafluoroantimonate, 7-[di(p-tolyl)sulfonium]-2-isopropyl tetrakis(pentafluorophenyl)borate, phenylcarbonyl-4′-diphenylsulfonium diphenylsulfide hexafluorophosphate, phenylcarbonyl-4′-diphenylsulfonium diphenylsulfide hexafluoroantimonate, 4-tert-butylphenylcarbonyl-4′-diphenylsulfonium diphenylsulfide hexafluorophosphate, 4-tert-butylphenylcarbonyl-4′-diphenylsulfonium diphenylsulfide hexafluoroantimonate, 4-tert-butylphenylcarbonyl-4′-diphenylsulfonium diphenylsulfide tetrakis(pentafluorophenyl)borate, diphenyl [4-(phenylthio)phenyl]sulfonium hexafluoroantimonate and the like can be cited as specific examples of the aromatic sulfonium complex salt that can be used. Certain ferrocene compounds, such as Irgacure 261 manufacture by Ciba Specialty Chemicals may also be used. The photoinitiators (B) can be used alone or as mixtures of two or more compounds. The photoinitiator (B) as a solution in a carrier solvent such as propylene carbonate may as be used.

There is no one preferred photoinitiator, but the most frequently used photoinitiators are photoacid generators consisting of triaryl sulfonium salts or a mixture of triaryl sulfonium salts with structures shown below as Formula 1, or diaryl iodonium salts with structures shown below as Formula 2, where Ar may represent the same aryl group or a mixture of aryl groups. Trialkyl sulfonium or dialkyl iodonium or mixed alkyl aryl salts can also be used. Most commonly used are hexafluorophosphate or hexafluoroantimonate salts, but other strong acid salts such as tetra(perfluorophenyl)boric acid or tris(trifluoromethylsulfonium)methide can be utilized. Such materials are commercially available from Dow Chemical Company under the trade names CYRACURE® Cationic Photoinitiators UVI-6990 or UVI-6976, which consist of approximately 50% solutions of PF₆ and SbF₆ salts, respectively, of a mixture of compounds of Formula 1 dissolved in propylene carbonate; from San Apro Co., Ltd. under the trade names CPI-100P or CPI-101A which consist of approximately 50% solutions of essentially pure PF₆ and SbF₆ salts, respectively, of Formula 1 dissolved in propylene carbonate and CPI-110A the 100% solids SbF₆ salt; from Ciba Specialty Chemicals under the trade name Irgacure 125, which consists of an essentially pure solid PF₆ salt of Formula 2 dissolved in propylene carbonate; and from Hampford Research under the name OPPI, which also consists of an essentially pure solid SbF₆ salt of Formula 2. In addition, the essentially pure solid PF₆ salt of Formula 2 is also available from Hampford Research under the name OPPI-PF₆. Others include the tetra(perfluorophenyl)borate salts from San Apro Co. LTD or Rhodia Electronics Catalysis sold commercially under the tradenames K-1 and Rhodosil 2074, respectively. The most preferred photoinitiators are those salts which do not contain any added solvent. 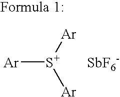 Ar—I—Ar X⁻ Formula 2:

The amount of polyfunctional resin (A) that may be used is preferably from about 99.9% to about 85% of the total weight of components (A) and (B); and more preferably from about 99% to about 90% by weight; and most preferably from about 98% to about 93% by weight of those two components. Where (B) is used as a solution, (B) is calculated on the weight of active content only.

The amount of photoacid generator compound or other thermally stable photosensitive material (B) that may be used is preferably from about 0.1% to about 15% by weight, based on the total weight of component (A) and (B). It is more preferred to use from about 1% to about 10% by weight of (B) and most preferably, from about 1% to about 7% by weight, based on the total weight of (A) and (B).

In addition to components (A) and (B), the compositions may optionally comprise one or more of the following additive materials: (C) one or more non-functional or unreactive polyfunctional resins; (D) one or more reactive monomers; (E) one or more photosensitizers; (F) one or more adhesion promoters: (G) one or more light absorbing compounds including dyes, pigments and phosphors; (H) one or more surface leveling agents. In addition to components (A) through (H) inclusively, the compositions may optionally further comprise additional materials including, without limitation, flow control agents, thermoplastic and thermosetting organic polymers and resins, as well as organic and inorganic filler materials.

Optionally, it may be beneficial in certain embodiments to use non-functional or unreactive resins (C) in the composition. The term “non-functional or unreactive resin” as applied to component (C) means a resin, polymer or oligomer that does not react with component (A) when the composition is exposed to actinic radiation and/or when optionally subsequently heated. Depending on its chemical structure, optional resin (C) may be used to: adjust the lithographic contrast of the photoimageable coating, modify the optical absorbance of the photoresist film, or improve the toughness or elongation of the coating or combinations of these and other physical properties. These may include among others acrylate and methacrylate resins, acrylate and methacrylate homopolymers and copolymers, methacrylate monomers such as pentaerythritol tetra-methacrylate and dipentaerythritol penta- and hexa-methacrylate, methacrylate oligomers such as urethanemethacrylate, polyester polymethacrylate, and the like. Polyether sulfone, polystyrene, polycarbonate, and the like are cited as other examples of thermoplastic resins which may be added. Still further examples of optional resins suitable for use include thermoplastic polyester resins such as polyethyleneterephthalate adipate, polybutyleneterephthalate sebacate and the like, thermoplastic polyamide resins such as Versamelt from Creanova, thermoplastic polyvinylethers such as Lutonal A from BASF, polyols polypropylene glycols or modified soybean, castor bean and linseed oils, novolak resins such as Epon 828 from Resolution Performance Products, plasticizers such as ENGAGE® manufactured by DuPont Dow, stress modifiers like siloxane modified phenolic novolak resin SD-788A from Borden Chemical, Kraton G from Kraton Polymers and SILAPLANE from Chisso Corp, tackifiers such as the branched olefin polymers L-1203 from Kraton Polymers and the hydrogenated polybutadienes GI-1000, 2000, and 3000 from Nippon Soda Co., Ltd., flame retardants such as tetrabromobisphenol A novolacs or phosohorus containing polymers and interpenetrating network polymers such as Versamelt 732 and the like from Creanova. The amount of (C) used may be preferably from about 0.1% to about 70% by weight of the combined weights of components (A) and (C).

Optionally, it may be beneficial in certain embodiments to use a reactive monomer compound (D) in the compositions according to the invention. Glycidyl or vinyl ethers are examples of reactive monomer (D) that can be used. Compounds with two or more functional groups are preferred and diethylene glycol diglycidyl ether, propylene glycol diglycidyl ether, polypropylene glycol diglycidyl ether, hexanediol diglycidyl ether, trimethylolpropane triglycidyl ether, pentaerythritol tetraglycidyl ether, diethyleneglycol divinylether, triethyleneglycol divinylether, cyclohexane dimethylolvinylether, and the like are cited as examples. The glycidyl ethers can be used alone or as mixtures of two or more. Aliphatic and aromatic monofunctional and/or polyfunctional oxetane compounds are another group of optional reactive monomers (D) that can be used in the present invention. Specific examples of the aliphatic or aromatic oxetane reactive monomers that can be used include 3-ethyl-3-hydroxymethyloxetane, 3-ethyl-3-phenoxymethyloxetane, xylylene dioxetane, bis(3-ethyl-3-oxetanylmethyl)ether, and the like. These monofunctional and/or polyfunctional oxetane compounds can be used alone or as mixtures of two or more. Alicyclic epoxy compounds can also be used as reactive monomer (D) in this invention and 3,4-epoxycyclohexylmethyl methacrylate and 3,4-epoxycyclohexylmethyl-3′,4′-epoxycyclohexane carboxylate may be cited as examples. If used, the amount of (D) used may be preferably from 0.1% to about 10% by weight of the combined weights of reactive components (A), (D) and (F).

Optionally, it may be useful to include photosensitizer compounds (E) in the composition so that more ultraviolet rays are absorbed and the energy that has been absorbed is transferred to the cationic photopolymerization initiator. Consequently, the process time for exposure is decreased. Anthracene, N-alkyl carbazole, and thioxanthone compounds are examples of photosensitizers that can be used in the invention. Anthracene compounds with alkoxy groups at positions 9 and 10 (9,10-dialkoxyanthracenes) are preferred photosensitizers (E). C₁ to C₄ alkoxy groups such as methoxy groups, ethoxy groups, and propoxy groups are cited as the preferred alkoxy groups. The 9,10-dialkoxyanthracenes can also have substituent groups. Halogen atoms such as fluorine atoms, chlorine atoms, bromine atoms, and iodine atoms, C₁ to C₄ alkyl groups such as methyl groups, ethyl groups, and propyl groups, sulfonic acid groups, sulfonate ester groups, carboxylic acid alkyl ester groups, and the like are cited as examples of substituent groups. C₁ to C₄ alkyls, such as methyl, ethyl, and propyl, are given as examples of the alkyl moiety in the sulfonic acid alkyl ester groups and carboxylic acid alkyl ester groups. The substitution position of these substituent groups is preferably at position 2 of the anthracene ring system. 9,10-Dimethoxyanthracene, 9,10-diethoxyanthracene, 9,10-dipropoxyanthracene, 9,10-dimethoxy-2-ethylanthracene, 9,10-diethoxy-2-ethylanthracene, 9,10-dipropoxy-2-ethylanthracene, 9,10-dimethoxy-2-chloroanthracene, 9,10-dimethoxyanthracene-2-sulfonic acid 9,10-dimethoxyanthracene-2-sulfonic acid methyl ester, 9,10-diethoxyanthracene-2-sulfonic acid methyl ester, 9,10-dimethoxyanthracene 2-carboxylic acid, 9,10-dimethoxyanthracene-2-carboxylic acid methyl ester, and the like can be cited as specific examples of the 9,10-dialkoxyanthracenes that can be used in the present invention. Examples of N-alkyl carbazole compounds useful in the invention include N-ethyl carbazole, N-ethyl-3-formyl-carbazole, 1,4,5,8,9-pentamethyl-carbazole, N-ethyl-3,6-dibenzoyl-9-ethylcarbazole, and 9,9′-diethyl-3,3′-bicarbazole. Examples of thioxanthone compounds useful in the invention are 2-isopropyl-thioxanthone and 1-chloro-2-propoxy-thioxanthone. If used, the sensitizer compounds (E) can be used preferably alone or in mixtures of two or more in amounts from about 0.1% to about 10% by weight of component (B).

In certain embodiments, it may be useful to add an optional adhesion promoting material to the composition in order to create a stronger bond between the substrate and the dry film resist coating. Examples of optional adhesion promoting compounds (F) that can be used in the invention include: 3-glycidoxypropyltrimethoxysilane, 3-glycidoxypropyltriethoxysilane, 3-mercaptopropyltrimethoxysilane, 3-mercaptopropyltriethoxysilane, 3-methacryloyloxypropyltrimethoxysilane, vinyl trimethoxysilane, and the like. If used, these compounds may be preferably employed in amounts from about 0.1% to about 5% by weight of the total solids of the composition.

Optionally and in certain embodiments, it may be useful to include light absorbing compounds (G) that absorb actinic radiation, give a color to the photoimagable film, change color upon exposure to actinic radiation or to provide phosphorescent or laser emission. Light absorbing compounds can be used to better provide a relief image cross section that has a reverse tapered shape such that the imaged material at the top of the image is wider than the imaged material at the bottom of the image. Colored compounds can be used for easy visualization of the coated and imaged coating. Color change compounds provide a means to differentiate between the exposed and unexposed regions of the coating. Phosphors provide a means to make the film selectively phosphoscing in the imaged portions of the coating. Lasing compounds provide a means to make the film into a solid state lasing source. Benzophenone compounds such as 2,4-dihydroxybenzophenone and 2,2′,4,4′-tetrahydroxybenzophenone, salicylic acid compounds such as phenyl salicylate and 4-t-butylphenyl salicylate, phenylacrylate compounds such as ethyl-2-cyano-3,3-diphenylacrylate, and 2′-ethylhexyl-2-cyano-3,3-diphenylacrylate, benzotriazole compounds such as 2-(2-hydroxy-5-methylphenyl)-2H-benzotriazole, and 2-(3-t-butyl-2-hydroxy-5-methylphenyl)-5-chloro-2H-benzotriazole, coumarin compounds such as 4-methyl-7-diethylamino-1-benzopyran-2-one, thioxanthone compounds such as diethylthioxanthone, stilbene compounds, naphthalic acid compounds, azo dyes, are cited as specific examples of the light absorbing compounds (G) that can be used in the present invention Phthalocyanine blue, phthalocyanine green, iodine green, Victoria blue, crystal violet, titanium oxide, carbon black, naphthalene black, and the like are cited as examples of coloring agents or pigments. Color changeable compounds such as Photopia from Matsui Shikiso Chemical and Chromacolor from Chromacolor Intl. Ltd, photochromic compounds such as the spiroindanes, acid-base indicators such as methyl violet, bromphenol blue and bromcresol green or various phosphors known to those versed in the art. laser dyes such as Rhodamine G6, Coumarin 500, DCM (4-(dicyanomethylene)-2-methyl-6-(4-dimethylaminostyryl)-4H pyran)), Kiton Red 620, Pyrromethene 580, and the like are cited as specific examples of other light absorbing compounds (G) that can be used in the present invention either singly or as mixtures. When pigments or phosphors are used it is particularly useful to employ nanoparticulate compositions containing particles less than 50 nanometers in size. If used, these light absorbing compounds may be preferably used in amounts from about 0.1% to about 30% by weight of the total solids of the composition.

Suitable surface leveling agents (H) include fluoroaliphatic esters such as FC 430 or FC 4430 (3M Company), hydroxyl terminated fluorinated polyethers such as PolyFox PF-636 and PF-5620 (Omnova Solutions), fluorinated ethylene glycol polymers such as Fluor N-561 and 562 (Cytonix Corporation), silicones such as Baysilone 3739, acrylic polymer leveling agents such as Modaflow (Surface Specialties, Inc.) and the like. If used, these surface-leveling agents (H) may be preferably present from about 0.001% to about 1% by weight of the total solids of the composition.

In addition, optional particulate or fibrous organic or inorganic fillers such as amorphous silica, silicon oxide, aluminum oxide, titanium oxide, zinc oxide, indium tin oxide, talc, clay, barium sulfate, barium titanate, magnesium carbonate, calcium carbonate, aluminum hydroxide, montmorillonite clays, mica powder, phosphor powders, powders of high dielectric constant materials such as aluminum nitride, low dielectric constant materials such as polytetrafluoroethylene particles, electrically conductive materials such as carbon or silver particles, thermally conductive materials, flame retardants, organic fillers such as fluoropolymer powders, crosslinked polystyrene powder, carbon nanotubes, metal and metal alloys such as gold, silver, copper, nickel, tin, magnetic metals or metal alloys or their oxides among others can be used in the present invention, and if used, the content of filler may be preferably from about 0.1% to 80% weight of the composition. Particularly useful are nanoparticulate compositions of the above named fillers containing particles less than 50 nanometers in size. These small particles result in less scattered light and thus lead to better resolution capabilities of the resulting photoimagable compositions compared to larger particles.

When necessary, various other optional materials such as crosslinking agents can be further used in the present invention. Crosslinking agents can include, for example, methoxylated melamine, butoxylated melamine, and alkoxylated glycouril compounds. Cymel® 303 from Cytec Industries, West Patterson, N.J., is a specific example of a suitable methoxylated melamine compound. Powderlink® 1174 from Cytec Industries, West Patterson, N.J. is a specific example of an alkoxylated glycouril compound When these additives and the like are used, their general content in the composition of the present invention is preferably 0.05% to 3% by weight each, but this can be increased or decreased as needed in accordance with the application objective.

Virtually any photoimageable composition that contains a reactive resin and a photosensitive component can be used in this process so long as it is stable to the hot melt coating conditions for an amount of time necessary to melt the composition, transport it to the slot die, flow though the die and exit the die lips. Specific examples of photoimageable compositions which can be utilized in this process include, but are not limited to those described in U.S. Pat. Nos. 4,193,797, 4,193,799, 4,624,912, 4,882,245, 5,077,174, 6,204,456, 6,239,049, 6,794,451 and U.S. Patent Application Publication No. 2005-0260522. Examples of compositions which cannot be used in the process because they do not possess sufficient thermal stability are described in U.S. Pat. Nos. 3,469,982, 4,247,616, 6,060,215, 6,462,107, 6,495,309, and 6,716,568.

The coating compositions of the present invention can be prepared by combining components (A) and (B) and optional components (C) though (H) and when necessary, other optional ingredients such as organic or inorganic fillers and other additives, in any order, preferably at the above-mentioned amounts or ratios, mixing uniformly, dispersing, and the like while heating the composition to a liquid melt state at temperatures below the decomposition temperature of any of the components in the mix. Alternatively, the coating compositions of the present invention can be prepared by combining components (A) and (B) and optional components (C) though (H), preferably at the above-mentioned amounts or ratios, mixing uniformly in an appropriate solvent such as acetone, methyl ethyl ketone, pentanone, cyclopentanone, ethyl acetate or dioxolane, for example, and then stripping or distilling the solvent from the mixture while heating until an essentially solvent free melt is obtained. Optionally, the thermally least stable components may be reserved and added only near the end of the overall mixing process. The mixing can be conducted in a heated chemical reactor or mixing vessel while stirring with a paddle mixer or agitator, or similar devices known in the compounding art, or it can be conducted within the confines of the heated barrel of a single or double screw polymer extrusion equipment. The solvent solution or liquid melt can then be subjected to high efficiency filtration to remove contaminates above 10 μm in size from the coating mixture. The composition can be used immediately while still hot or it can be packaged and stored for use at a later date.

The composite article of dry film photoresist is comprised of at least two layers. The first layer is a flexible film comprised of an organic polymer film or a metal foil or a combination of both and is commonly known in the art as the carrier sheet, web or web material. Optionally, the web material may be a composite structure having a single or multiple layers of photoimageable or non-photoimageable resin films. The second layer is a dried or substantially dried coating of the above-noted photoimageable coating composition. Optionally, other layers may be present such as a thin coating on the web material designed to provide improved wetting or de-wetting characteristics or protective cover films that are placed on the dried photoresist coating.

Web materials that may be used are those films or foils that: provide a surface wettable with the liquid formulation; provide sufficient adhesion with the coating so that the coating sticks to the substrate film; optionally provides low enough adhesion so that the photoresist coating does not adhere to the web when the composite film is laminated to a substrate and the web is removed; and provides sufficient dimensional stability to the composite article during its manufacture and subsequent use. Examples of web materials suitable for use include, but are not limited too, polyester film such as Mylar® polyesters available from Dupont-Teijin Films, polyimide films such as Kapton® polyimides available from Dupont, copper clad polyimide film, copper, aluminum, nickel, brass, or stainless steel foils, and the like. Other usable web materials include polyethylene naphthalate (PEN), polyvinyl chloride (PVC), polymethylmethacrylate (PMMA) and polycarbonate (Lexan) films, brass, titanium, tantalum, nickel, chrome, tungsten and molybdenum foils and the like. Preferably the carrier sheet is an oriented polyethylene terephthalate (PET) polyester sheet such as Mylar A due to its lower cost. The thickness of the carrier sheet can be from 10 μm to 150 μm thick, but preferably 20 to 50 μm thickness functions best for subsequent coating and laminating operations.

Optionally, a protective cover film may be placed in contact with the photoresist layer. A suitable protective cover film must have low adhesion to the photoresist coating so that it can be removed from the dry film photoresist without pulling the photoresist coating away from the web material but high enough so that it does not separate from the film during use or storage. Use of protective cover films is preferred when the dry film photoresist is wound on rolls for storage and subsequent use. Cover sheet films suitable for use include films made from polyester, polyimide, polyethylene, polypropylene, fluoropolymers, and polyesters with silicones or fluoropolymers or coatings thereof. The cover sheet is preferably PET, 10 to 25 μm thick.

The photoimagable coating layer is applied to the web material in the molten state using methods commonly used for applying hot melt adhesive films. The methods suitable for use provide a means of controlling the thickness of the coating across both the width and length of the coated film and a defect free film surface. The most preferred arrangement is to use a system of integrated machinery which contains heated polymer extrusion equipment or a heated reservoir to contain the molten resin, a metering pump, a heated distribution manifold to controllably spread the hot resin and a heated coating module, each of which can be heated at the same or different temperatures and in which the web material is unwound from a stock roll, passed continuously through a linked system past a coating module, and then rewound on a roll to provide the dry film photoresist in roll format that can be stored for subsequent use. Alternatively, the coated element can be fed past the take-up roll and cut into sheets which can also be stored for subsequent use instead. The linked system may further comprise a module for applying a protective cover sheet prior to forming the roll of dry film photoresist and may further comprise measurement equipment used to monitor the thickness of the photoresist coating and to detect flaws in the surface of the dried photoresist. The most preferred coating module is commonly referred to as a slot die coater and consists of a highly machined slot opening in the coating head with slot dimensions ranging from less than 1 millimeters to no more than two millimeters in height and from a few cm to more than 150 cm in width. The web is then passed within a few millimeters of this slot and the resin is discharged continuously onto the web at a rate controlled by the distribution manifold. Coating thickness is readily controlled by a combination of the web speed and the resin feed rate.

The production of the photosensitive element is more precisely accomplished by using the hot melt from above or by melting the cooled, solid resin in a hot melt processor such as those available from May Coating Technologies, St. Paul, Minn., or in a single or double screw polymer extruder. It is preferred that volatile materials and undesired particulate matter be removed from the melt prior to processing. The melt is then fed from the melt processor or extruder to the inlet of the slot die manifold under controlled temperature and feed rate conditions by means of a metering pump and then through the manifold and through the coating lips onto the moving web. Preferably a filter is employed between the metering pump and the manifold inlet. The temperature of the melt in the coating die and at the die lips varies depending on the viscoelastic properties on the melt and composition of the resin. The temperature must be sufficiently high that the resin will flow but not so high as to degrade the composition. As a general guideline the temperature can typically range from 90° C. to over 150° C. and the web can be run at as little as 5 ft/min or in excess of 200 ft/min. The carrier sheet (web) is a flexible, heat-resistant, inelastic, self-supporting film or foil described above.

During coating, the web is placed in very close proximity (less than 2 millimeters gap) to the die lips so that the exit bead of the melt is coated directly onto the web. The web is held tight to the surfaces of a coating drum which provides a structural integrity to the composite film. The slot die coated composition is immediately cooled under controlled conditions on the carrier sheet to partially harden the coating while passing the web over the coating drum. One or more cooled or warmed “chill” rolls can be used for contacting the carrier sheet to produce the controlled temperature reduction. A protective cover sheet is then applied to the top surface of the coating, preferably while still slightly warm or while being gently heated, while passing the web through a nip roller to provide a smooth uniform seal between the two. The composite element is then wound onto the take-up roll. Preferably the entire coating process is conducted under clean room conditions (Class 10 or Class 100) under static control, and the carrier film and cover sheet materials are both cleaned of any attached particulate materials prior to coating.

The slot die can be of any standard design, but a “coathanger” type design is preferred in order to more evenly control the distribution of the melt across the die, thereby controlling the coating thickness profile. Other distribution arrangements may be used as known to those skilled in the art. The length of the die will depend on the width of the composite to be made. For coatings having a thickness of 1 millimeter or less a substantially constant slot width across the die is preferred. Although the die lips can be textured or smooth, smooth is highly preferred. Most preferably the lips should be highly polished to minimize variations and defects in the coating. The lips surface may be treated with a coating, for instance electroplating, nitriding, or other depositing techniques, to improve die surface smoothness, provide corrosion resistance or improve flow properties over the lips. It is preferred to use stainless or tool grade steel for the die and lips.

In one embodiment, the dry film photoresist is used as is, that is either by first peeling the protective cover sheet from the photoresist layer or leaving it in place, wherein the web base material becomes the substrate which may be subsequently processed image-wise using the methods described herein. In another embodiment, the dry film photoresist is used by first peeling the protective cover sheet from the photoresist layer, placing the dry film on a substrate with the photoresist side in contact with the substrate, laminating the photoresist to the substrate by application of heat and pressure using a lamination device and then peeling the base web film from the photoresist. In yet a third embodiment, the base web layer is removed first, the dry film is placed in contact with the substrate and laminated to the substrate by the application of heat and pressure and the remaining coversheet is left in place. These operations result in forming a photoresist layer on a substrate which may be subsequently processed image-wise using the methods described herein. Alternatively, the web base material can be used as the substrate and can be processed imagewise either with or without removal of the protective cover layer using methods described herein. If the coversheet is left in place it is preferable to expose the composite through the thinner of the two films which is usually the coversheet.

Further, two or more multiple layers can be coated onto the same web base substrate. These additional layers can be on the same side of the substrate or on opposite sides. If they are on the same side of the substrate they can be coated at the same time as the first by the use of sequential coating heads arranged around the main coating roller. When they are on the same side they are typically of different materials of the same or different compositions with different material properties. In this embodiment the coversheet is applied on top of the last coat applied. The multiple layers can also be coated on opposite sides of the web. In this case the second film must be coated onto the opposite side of the web base from the first layer at a second coating head positioned on a second coating roller where the coated side of the composite is now in contact with the second coating roller and the new coating layer is applied to the back side of the web base. It is preferable that the coversheet be applied before the application of the second coating so that the coversheet is now in contact with the second coating roller and not the applied composition. Alternatively, the take up roll of the coated composite of the first layer, preferably with an applied coversheet, can be placed so as to become the web base for the second run, provided that the base is installed so that the coated side of the composite or the coversheet thereon is now in contact with the coating roller and the new coating layer is applied to the back side of the original web base. In the case that the two coatings are on opposite sides of the web they are typically of the same composition; however different compositions can be used. Additional layers can be further applied if desired.

The solid photoresist coatings can be photoimaged using an exposure tool with near-ultraviolet radiation from a medium- or high-pressure mercury lamp or x-ray radiation from synchrotron or other illumination sources through a photomask containing a pattern of opaque and transparent regions. Contact, proximity, or projection printing may be used. Alternatively, the coating may be exposed with either electron beam radiation or other types of actinic radiation. Following exposure, a post-exposure-bake may be carried out, if required, in order to accelerate the catalyzed polymerization reaction in the exposed regions of the coating. Typical bakes are carried out on a hotplate for as little as 1 minute at 60° C. to as much as 10 or 15 minutes at 95° C. If the cover sheet was left in place during the exposure it is preferably removed before this post-exposure-bake (PEB) process. After the bake an optional relaxation step may be employed to help reduce internal stresses within the exposed resist areas. Alternatively, the substrate can be cooled slowly back to room temperature either step wise or under a controlled decrease in temperature.

After PEB the coating is then immersed in an organic solvent or aqueous alkaline base developer, typically for 2-5 minutes for thinner films to as much as 60 minutes or more for thick films approaching 1 millimeter in thickness, depending also on the solvent strength of the developer, in order to dissolve away the soluble regions. Agitation, either gentle motion, ultrasonic or megasonic, may also be employed to assist in the rate and completeness of the develop process. The developed image, which can be either negative or positive in tone, is preferably rinsed by application of a rinse solvent or deionized water to remove residual developer. Removal of the residual developer may be necessary because the residual developer may contain dissolved photoresist components that will form deposits in the relief image if the residual developer is allowed to dry on the substrate. Optionally, after development a post-bake or cure may be performed on the resulting image to more completely harden the material by driving the polymerization reaction to a higher degree of conversion for cross-linking types of negative resists.

Optionally, the developer may be applied by spraying using either an atomizing spray nozzle or fine shower-head type spray nozzle. Yet another method of developing the image comprises applying the developer using what is known in the photoresist art as a puddle process wherein the substrate to be developed is placed on a rotating tool head and then an amount of developer sufficient to form a standing layer or puddle on the entire substrate area is dispensed onto the substrate and allowed to stand for a defined period of time. After this time, the substrate is rotationally accelerated to spin off the spent developer and then decelerated until rotation stops. This sequence is repeated until a clear relief image is obtained and it is common to use a process wherein two to four solvent puddles are formed.

Suitable organic developer solvents include, but are not limited to, propylene glycol methyl ether acetate, gamma-butyrolactone, acetone, cyclopentanone, 2-pentanone, 3-pentanone, diacetone alcohol, tetrahydrofurfuryl alcohol, propylene carbonate, N-methylpyrrolidone, and ethyl lactate. The developer solvents can be used singly or as mixtures. Propylene glycol methyl ether acetate is particularly preferred because of its good solvency for the unexposed photoresist components, low toxicity and relatively low cost.

Suitable alkaline developers include aqueous solutions of tetramethylammonium hydroxide, sodium hydroxide, potassium hydroxide, sodium or potassium carbonate or silicate or other similar alkaline materials.

Suitable rinse solvents include any of the developer solvents mentioned above as well as methanol, ethanol, isopropanol, and n-butyl acetate and the like. It is preferred that the rinse solvents dry quickly and in this regard acetone, methanol, ethanol, and isopropanol are particularly preferred. If aqueous based developers are used the most common rinse solvent is deionized water.

The solvent-free melt compositions according to the invention or the cooled solid version thereof, while intended for use in the manufacture of dry film photoresists, may also be used to prepare liquid photoresists by dissolving the composition in an appropriate solvent. When used as a conventional liquid photoresist, the photoresist compositions of the present invention may be applied to a substrate by spin-coating, consisting of dispensing the liquid photoresist onto a substrate, accelerating the substrate to a constant rotational speed, and holding the rotation speed constant to achieve the desired coating thickness. Spin-coating may be performed with variable rotational velocity in order to control the thickness of the final coating. Alternatively, the photoresist composition may be applied to the substrate using other coating methods such as dip or spray coating, roller coating, spray coating, screen coating or slot die coating. After coating, a drying bake is performed to evaporate the solvent. The drying bake conditions are chosen so as to form a tack free film of photoresist. Alternatively, the drying bake may be performed in a convection oven. The photoresist is then exposed and developed as described above. Further the liquid photoresist formulation may be slot die coated, for instance, onto a base web material to form a photoresist element of a similar composition as that prepared according to this invention.

A variety of conventional substrate materials may be processed using dry film photoresist compositions of the present invention. Suitable substrates include, but are not limited to, silicon, silicon dioxide, silicon nitride, alumina, glass, quartz, fused silica, ceramics, glass-ceramics, gallium arsenide, indium phosphide, copper, aluminum, nickel, iron, steel, stainless steel, copper-silicon alloys, indium-tin oxide coated glass, organic films such as polyimide and polyester, as well as dry film layers previously imaged, including dry film layers of the present invention, and any substrate bearing patterned areas of metal, semiconductor, and insulating materials, and the like. No special pre-treatment of the substrate is necessary for operation of the invention. Optionally, a bake step may be performed on the substrate to remove absorbed moisture or an oxygen plasma treatment may be performed to remove residual organic species from the surface prior to applying the photoresist coating. When a metal foil is used as the base web material it will typically become the substrate when the photosensitive layer is subsequently processed image-wise using the methods described herein.

The photoresist compositions according to the invention have excellent imaging and adhesion characteristics virtually equivalent to their solvent cast versions.

The laminated, imaged and optionally cured product of the compositions according to the invention may be used in most of the applications where liquid photoimageable compositions have been used. The only limitations on use of the dry film photoresists of the present invention as a replacements for liquid photoresists is that the article of manufacture must comprise a substrate that can be subjected to the lamination conditions of heat and pressure necessary to affix the dry film photoresist to the substrate in a manner suitable to the intended use and that the properties of the resulting structure meet the needs of the intended use. These coated substrates can be subjected to conventional processes (e.g. etching, plating and the like) to treat the exposed surfaces on the substrate. If the web base material is used as the substrate then free-standing polymer structures can be readily obtained due to the easy removal from the web film after processing as described by Aguirregabiria, Proceedings μTAS 2004, Malmo, p363 (2004).

Several U.S. patents teach the use of dry film photoresists to make electrical printed circuit boards, offset printing plates and other copper-clad laminates. These include: U.S. Pat. Nos. 3,469,982; 4,193,799; 4,576,902; 4,624,912 and 5,043,221. U.S. Pat. No. 3,708,296 teaches the use of dry film photoresist in making acid and alkali resistant images for chemical milling, screenless lithography, printing plates, stencil making, microimages for printed circuitry, thermoset vesicular images, microimages for information storage, decoration of paper, glass and metal packages and light cured coatings. The laminated, imaged and cured products of the present invention may be used in place of the dry film photoresists disclosed in these references.

As another example, the laminated, imaged, and optionally cured product of specific compositions according to this invention may be used in place of SU-8 resin containing liquid photoresists in electronic packaging applications related to forming protective coatings on semiconductor wafers and singulated devices as taught in U.S. Pat. No. 6,544,902.

In a further example, the laminated, imaged, and optionally cured products of the compositions according to the invention may be used in place of SU-8 resin containing liquid photoresists to form a reactive ion etch mask used in the fabrication of high density, area array printing plates for printing biological inks as disclosed in US Patent Application No. 2003/0059344 or in the fabrication of cell transfection plates and transfection apparatus as disclosed in U.S. Pat. Nos. 6,652,878 and 6,670,129. As an additional example from field of biological applications, the compositions according to the invention may be used to fabricate a plurality of microfluidic channels in devices for parallel, in-vitro screening of biomolecular activity as taught in U.S. Pat. Nos. 6,576,478 and 6,682,942.

In the field of MEMS, the laminated, imaged, and optionally cured products of the compositions according to the invention may be used in place of SU-8 resin containing liquid photoresists for the fabrication of: micro-power switching devices as taught in U.S. Pat. No. 6,506,989; insulating layers in microrelay devices as taught in U.S. Pat. No. 6,624,730; drug delivery devices and sensors as taught in U.S. Pat. No. 6,663,615; multilayer relief structures as described in U.S. Pat. No. 6,582,890; and electromagnetic actuators as described in U.S. Pat. No. 6,674,350. Further and in the area of sensors, the compositions may be used, for example, in the fabrication of ultraminature fiber optic pressure transducers as taught in U.S. Pat. No. 6,506,313 and the fabrication of cantilever tips for application in atomic force microscopy (AFM) as taught in U.S. Pat. No. 6,219,140.

There have been numerous disclosures on the utility of liquid SU-8 resin containing photoresists in the fabrication of the print head component of ink jet printer cartridges wherein the laminated, imaged, and optionally cured products of the compositions according to this invention may be used in place of SU-8 resin containing liquid photoresists. A by no means inclusive, but illustrative group of examples showing applications in the area of ink jet print heads include the teachings of U.S. Pat. Nos. 5,859,655, 6,193,359, 5,969,736, 6,062,681, 6,419,346, 6,447,102, 6,305,790, and 6,375,313

Similarly, virtually all of the utility applications claimed for SU-8 resin containing liquid photoresists formulations in U.S. Patent Application Publication No. 2005-0260522 can similarly be prepared from similar SU-8 resin containing composite elements of the invention.

The present invention is further described in detail by means of the following Examples and Comparisons. All parts and percentages are by weight and all temperatures are degrees Celsius unless explicitly stated otherwise.

### EXAMPLES

Methods for Formulating Dry Film Photoresist Coating Compositions

### Example 1

### Formulation of Dry Film Coating Composition Using Hot Melt Processing

A dry film photoresist coating composition was made by combining the components in Table 1 as shown below.

TABLE 1
Formulary of the dry film photoresist coating composition of Example 1.

| | | | Weight | Weight % | Weight % |
|---|---|---|---|---|---|
| Material | Type | Supplier | grams | on A + D + F | of Comp |
| SU-8 Resin | Resin A | Resolution Performance | 145.0 | 72.5 | 67.1 |
| | | Products | | | |
| NC-3000H | Resin A | Nippon Kayaku Co., Ltd. | 40.0 | 20.0 | 18.5 |
| Resin | | | | | |
| Heloxy | Reactive | Resolution Performance | 12.0 | 6.0 | 5.6 |
| Modifier 48 | Monomer D | Products | | | |
| Z6040 Silane | Adhesion | Dow Corning Company | 3.0 | 1.5 | 1.4 |
| | Promoter F | | | | |
| Cyracure 6974* | PAG B | Dow Chemical Company | 16.0 | 8.0 | 7.4 |
| Total | | | 216.0 | | 100 |

*Cyracure 6974 contains a nominal 50.0 weight % of aryl sulphonium hexafluoroantimonate salts in propylene carbonate solvent.

A 250 ml beaker containing a magnetic stirrer and wrapped with a heating tape was placed on a magnetic stirrer hot plate. To this was added the Reactive Monomer D and the Adhesion Promoter F. This was heated to approximately 100° C., then NC-3000H Resin A was added portionwise over 15 minutes maintaining the temperature at 90-100° C. and stirred until melted. The temperature was increased to 120-125° C. and the SU-8 Resin A was added portionwise and the mixture heated for 30 min until completely melted and thoroughly mixed. To this was added the PAG B at 125-130° C. This was cooled slowly over four (4) hours while the viscosity was measured as the temperature dropped. The following viscosities were measured:

| Temp, ° C. | Visc, P |
|---|---|
| 125 | 1.9 |
| 120 | 14 |
| 115 | 19 |
| 110 | 24 |
| 105 | 32 |
| 100 | 43 |
| 95 | 64 |
| 90 | 107 |
| 85 | 216 |
| 80 | 390 |
| 75 | 710 |

After reheating to 125° C. the melt was poured quickly onto aluminum foil. Upon cooling the resin was removed from the foil and stored in a polyethylene bag.

### Examples 2-6

### Dry Film Photoresist Compositions were Made by Combining the Components as Shown in Table 2

TABLE 2
Formulary of the dry film photoresist coating compositions of Examples 2-6.

| | | | Example 2 | Example 3 | Example 4 | Example 5 | Example 6 |
|---|---|---|---|---|---|---|---|
| | | | Weight, | Weight, | Weight, | Weight, | Weight, |
| | | | gms | gms | gms | gms | gms |
| | | | (% on | (% on | (% on | (% on | (% on |
| Material | Type | Supplier | A + D + F) | A + D + F) | A + D + F) | A + D + F) | A + D + F) |
| SU-8 Resin | Resin A | Resolution | 137.0 | 137.0 | 137.0 | 137.0 | 137.0 |
| | | Performance | (68.5) | (68.5) | (68.5) | (68.5) | (68.5) |
| | | Products | | | | | |
| NC-3000H Resin | Resin A | Nippon Kayaku | 50.0 | — | 50.0 | 50.0 | 50.0 |
| | | Co., Ltd. | (25.0) | | (25.0) | (25.0) | (25.0) |
| NER-7604 Resin | Resin A | Nippon Kayaku | — | 50.0 | — | — | — |
| | | Co., Ltd. | | (25.0) | | | |
| Heloxy Modifier 48 | Reactive | Resolution | 10.0 | 10.0 | 13.0 | 13.0 | 13.0 |
| | Monomer D | Performance | (5.0) | (5.0) | (6.5) | (6.5) | (6.5) |
| | | Products | | | | | |
| Z6040 Silane | Adhesion | Dow Corning | 3.0 | 3.0 | — | — | — |
| | Promoter F | Company | (1.5) | (1.5) | | | |
| Cyracure 6974* | PAG B | Dow Chemical | — | — | — | 8.0 | — |
| | | Company | | | | (4.0) | |
| OPPI | PAG B | Hampford | 8.0 | 8.0 | 8.0 | — | — |
| | | Research | (4.0) | (4.0) | (4.0) | | |
| | | Products | | | | | |
| CD-1012 | PAG B | Sartomer | — | — | — | — | 8.0 |
| | | | | | | | (4.0) |
| 2-Ethoxy-8,9- | Sensitizer E | Hampford | 0.12 | 0.12 | 0.12 | — | 0.12 |
| dimethoxy | | Research | (0.06) | (0.06) | (0.06) | | (0.06) |
| anthracene | | Products | | | | | |
| Total | | | 208.12 | 208.12 | 208.12 | 208.0 | 208.12 |

*Cyracure 6974 contains a nominal 50.0 weight % of aryl sulphonium hexafluoroantimonate salts in propylene carbonate solvent.

For examples 2-6, a 250 ml beaker containing a magnetic stirrer and wrapped with a heating tape was placed on a magnetic stirrer hot plate. To this was added Resins A, the Reactive Monomer D and the Adhesion Promoter F. This was heated to 90-100° C. until completely melted and thoroughly mixed. The PAG B and Sensitizer E were mixed together, added to the resin melt and stirred for 5 min. The melt was then poured into a glass jar and cooled.

### Examples 7-9

### Dry film Photoresist Compositions were Made by Combining the Components as Shown in Table 3

TABLE 3
Formulary of the dry film photoresist coating compositions of Examples 7-9.

| | | | Example 7 | Example 8 | Example 9 |
|---|---|---|---|---|---|
| | | | Weight, gms | Weight, gms | Weight, gms |
| Material | Type | Supplier | (% on A + D + F) | (% on A + D + F) | (% on A + D + F) |
| SU-8 Resin | Resin A | Resolution | 685.0 | 685.0 | 267.5 |
| | | Performance | (68.5) | (68.5) | (53.5) |
| | | Products | | | |
| NC-3000H Resin | Resin A | Nippon Kayaku | 250.0 | 250.0 | 125.0 |
| | | Co., Ltd. | (25.0) | (25.0) | (25.0) |
| NER-7604 Resin | Resin A | Nippon Kayaku | — | — | 75.0 |
| | | Co., Ltd. | | | (15.0) |
| Heloxy Modifier 48 | Reactive | Resolution | 65.0 | 65.0 | 32.5 |
| | Monomer D | Performance | (6.5) | (6.5) | (6.5) |
| | | Products | | | |
| Z6040 Silane | Adhesion | Dow Corning | — | — | — |
| | Promoter F | Company | | | |
| Cyracure 6974* | PAG B | Dow Chemical | — | 80.0 | — |
| | | Company | | (8.0) | |
| OPPI | PAG B | Hampford | — | — | — |
| | | Research | | | |
| | | Products | | | |
| CD-1012 | PAG B | Sartomer | 40.0 | — | — |
| | | | (4.0) | | |
| 2-Ethoxy-8,9- | Sensitizer E | Hampford | 0.60 | — | — |
| dimethoxy | | Research | (0.06) | | |
| anthracene | | Products | | | |
| Total | | | 1040.6 | 1080.0 | 500.0 |

*Cyracure 6974 contains a nominal 50.0 weight % of aryl sulphonium hexafluoroantimonate salts in propylene carbonate solvent.

All components except PAG B were weighed into a tared 1 liter resin kettle. The kettle was fitted with a mechanical stirrer, a thermometer, an addition port, a vacuum port and a heating mantle. The mixture was then heated without stirring until the entire mixture had melted and the viscosity was sufficiently low to enable stirring. The mixture was then stirred at a temperature ranging from 80-105° C. for several minutes to several hours to effect complete mixing of the ingredients. PAG B was then added and stirring resumed for 15 minutes to obtain a homogeneous solution. The mixture was then placed under vacuum to remove dissolved gases and entrapped bubbles. When adequately “degassed” the equipment was quickly dismantled and the molten photoresist quickly poured into a suitable container.

### Examples 10-15

### Dry Film Photoresist Compositions were Made by Combining the Components as Shown in Table 4

TABLE 4
Formulary of the dry film photoresist coating compositions of Examples 10-15.

| | | Example | Example | Example | Example | Example | Example |
|---|---|---|---|---|---|---|---|
| | | 10 | 11 | 12 | 13 | 14 | 15 |
| | | Weight, | Weight, | Weight, | Weight, | Weight, | Weight, |
| | | gms | gms | gms | gms | gms | gms |
| | | (% on | (% on | (% on | (% on | (% on | (% on |
| Material | Type | A + D + F) | A + D + F) | A + D + F) | A + D + F) | A + D + F) | A + D + F) |
| SU-8 Resin | Resin A | 535.0 | 685.0 | 535.0 | 685.5 | 535.0 | 535.0 |
| | | (53.5) | (68.5) | (53.5) | (68.5) | (53.5) | (53.5) |
| NC-3000H Resin | Resin A | 250.0 | 250.0 | 250.0 | 250.0 | 250.0 | 250.0 |
| | | (25.0) | (25.0) | (25.0) | (25.0) | (25.0) | (25.0) |
| NER-7604 Resin | Resin A | 150.0 | — | 150.0 | — | 150.0 | 150.0 |
| | | (15.0) | | (15.0) | | (15.0) | (15.0) |
| Heloxy Modifier 48 | Reactive | 50.0 | 50.0 | 65.0 | 50.0 | 50.0 | 50.0 |
| | Monomer D | (5.0) | (5.0) | (6.5) | (5.0) | (5.0) | (5.0) |
| Z6040 Silane | Adhesion | 15.0 | 15.0 | — | 15.0 | 15.0 | 15.0 |
| | Promoter F | (1.5) | (1.5) | | (1.5) | (1.5) | (1.5) |
| Baysilone 3739⁺ | Surfactant H | — | — | — | — | — | 2.67 |
| | | | | | | | (0.20) |
| OPPI | PAG B | 40.0 | 40.0 | 40.0 | 10.0 | 75.0^{P} | 40.0 |
| | | (4.0) | (4.0) | (4.0) | (1.0) | (7.5) | (4.0) |
| 2-Ethoxy-8,9- | Sensitizer E | 0.40 | 0.40 | 0.40 | — | 1.0 | 0.40 |
| dimethoxy anthracene | | (0.040) | (0.040) | (0.040) | | (0.10) | (0.040) |
| Total | | 1040.4 | 1040.4 | 1040.4 | 1010.0 | 1076.0 | 1040.4 |

^{P}= OPPI PF₆ instead of OPPI
⁺75% solids solution in PGMEA

All components except PAG B were weighed into a tared 2 liter resin kettle. The kettle was fitted with a mechanical stirrer, a thermometer, an addition port, a vacuum port and a heating mantle. The mixture was then heated without stirring until the entire mixture had melted and the viscosity was sufficiently low to enable stirring, approximately 80° C. The mixture was then stirred at a temperature ranging from 80-100° C. for 5 to 15 minutes at approx. 30 rpm to effect complete mixing of the ingredients. The mixture was then slowly placed under reduced vacuum at 100-120° C. to remove dissolved gases and entrapped bubbles until a vacuum of approximately 10 torr had been obtained. When adequately “degassed” the vacuum was released and PAG B was then added and stirring resumed for 15 minutes to obtain a homogeneous solution. The melt mixture was then quickly placed under approximately 10 torr vacuum for 30 to 60 minutes to remove the additional dissolve gases and entrapped bubbles. When adequately “degrassed” the equipment was quickly dismantled and the molten photoresist quickly poured onto a flat PET or polyimide sheet and cooled. When cool, the resin was fractured into pieces and transferred into a suitable container.

### Prophetic Examples 1-9

### Dry Film Photoresist Compositions are Made by Combining the Components as Shown in Table 5

TABLE 5
Formulary of the dry film photoresist coating compositions of Prophetic Examples 1-9.

| Prophetic | | | | |
|---|---|---|---|---|
| Example | Representative Composition | Inventor | Type | System |
| 1 | U.S. Pat. No. 4,882,245 | Gelorme | Negative | SU-8 Resin A + PAG B |
| 2 | U.S. Pat. No. 4,940,651 | Brown | Negative | Epoxy Resin A + Epoxy Monomer D + PAG B |
| 3 | U.S. Pat. No. 4,193,799 | Crivello | Negative | Polyvinylacetal Resin A + Epoxy Resin |
| | | | | A + PAG B |
| 4 | U.S. Pat. No. 5,077,174 | Bauer | Positive | Cleavable Ester Resin A + PAG B |
| 5 | U.S. Pat. No. 4,624,912 | Zweifel | Negative | Epoxy Resin A + PAG B |
| 6 | U.S. Pat. No. 6,204,456 | Lauffer | Negative | Epoxy Resin A + PAG B |
| 7 | | | Negative | Epoxy Resin A + Vinyl Ether Resin |
| | | | | A + PAG B |
| 8 | | | Negative | Epoxy Resin A + Resin (C)1 + PAG B |
| 9 | | | Negative | Epoxy Resin A + Resin (C)2 + PAG B |

Prophetic Examples 1-9 are to be prepared in a manner similar to examples 7-9 above, wherein the photoresist components are mixed together in the absence of any solvent and melted and where the photosensitive component PAG A is withheld until the resin melt has been first degassed. Such 100% solid photoresist blends are to be collected and later coated as taught herein.

### Examples 16-18

### Scale-Up Dry Film Photoresist Compositions were Made by Combining the Components as Shown in Table 6

TABLE 6
Formulary of the dry film photoresist coating compositions of Examples 25-27.

| | | | Example | Example | Example |
|---|---|---|---|---|---|
| | | | 16 | 17 | 18 |
| | | | Weight, | Weight, | Weight, |
| | | | Kg | Kg | Kg |
| | | | (% on | (% on | (% on |
| Material | Type | Supplier | A + D + F) | A + D + F) | A + D + F) |
| SU-8 Resin | Resin A | Resolution Performance | 10.600 | 10.099 | 10.602 |
| | | Products | (50.5) | (53.0) | (53.0) |
| NC-3000H Resin | Resin A | Nippon Kayaku Co., Ltd. | 5.000 | 4.764 | 5.001 |
| | | | (23.8) | (25.0) | (25.0) |
| NER-7604 Resin | Resin A | Nippon Kayaku Co., Ltd. | 4.000 | 2.858 | 3.001 |
| | | | (19.0) | (15.0) | (15.0) |
| Heloxy Modifier 48 | Reactive | Resolution Performance | 1.100 | 1.048 | 1.108 |
| | Monomer D | Products | (5.2) | (5.5) | (5.5) |
| Z6040 Silane | Adhesion | Dow Corning Company | 0.300 | 0.286 | 0.309 |
| | Promoter F | | (1.43) | (1.5) | (1.5) |
| Baysilone 3739 | Surfactant H | Bayer | — | — | 0.082 |
| | | | | | (0.041) |
| 2-Pentanone | Solvent | Eastman Kodak | — | — | 30.000 |
| 2-Ethoxy-8,9- | Sensitizer E | Hampford Research | 0.0080 | 0.0076 | — |
| dimethoxyanthracene | | Products | (0.038) | (0.040) | |
| OPPI | PAG B | Hampford Research | 0.800 | 0.762 | — |
| | | Products | (3.80) | (4.0) | |
| CPI-101A* | PAG B | San Apro | — | — | 1.650 |
| | | | | | (8.24) |
| Total | | | 21.806 | 19.825 | 21.671 |

*CPI-101A contains a nominal 50.0 weight % of aryl sulphonium hexafluoroantimonate salt in propylene carbonate solvent.

The resin blends for examples 16-18 were separately prepared as follows. In Example 16 all components except PAG B were weighed into a 30 liter glass resin kettle. The kettle was fitted with a mechanical stirrer, a thermometer, an addition port, a vacuum port and a heating mantle. The mixture was then heated without stirring until the entire mixture had melted and the viscosity was sufficiently low to enable stirring, approximately 80° C. The mixture was then stirred at a temperature ranging from 80-100° C. for 5 to 15 minutes at approx. 30 rpm to effect complete mixing of the ingredients. In Example 17 all of the components except the PAG B and the Sensitizer E were premixed, melted and then stored in suitable containers. In this example the containers were subsequently re-heated at 90-100° C. until melted and then 19.055 Kg was poured into the 30 liter glass resin kettle and heated. In Example 18 all of the components, except the PAG B, were added in two equal portions, heated to about 80° C. without stirring until the entire mixture melted or dissolved, then stirred until homogeneous and poured off to give 50 Kg of a combined solution. The combined solution was microfiltered and then returned to the 30 liter glass resin kettle and the solvent stripped under reduced pressure.

The mixtures were then slowly placed under reduced vacuum at 100-120° C. to remove any residual solvent as well as the dissolved gases and entrapped bubbles until a vacuum of approximately 10 torr had been obtained. This yielded a 100% solids melt mixture. When adequately “degassed” the vacuum was released and the PAG B and Sensitizer E were added where applicable and stirring resumed for 15 minutes to obtain a homogeneous solution. The melt mixture was then quickly placed under approximately 10 torr vacuum for 30 to 60 minutes to remove the additional dissolve gases and entrapped bubbles. When adequately “degassed” the kettle was returned to atmospheric pressure using nitrogen gas and the molten photoresist was drained from the bottom take-off valve into a suitable container. When the PAG contained a high boiling carrier solvent such as propylene carbonate, the high boiling solvent was not removed by this process and the resulting molten mixture contained the residual carrier solvent.

### Example 19

### Formulation of a Dry Film Photoresist Coating Composition Using a Chemical Reactor or Mixing Vessel

A dry film photoresist composition was made by combining the components as shown in Table 7.

TABLE 7
Formulary of the dry film photoresist coating composition of Example 19.

| | | | Weight | Weight % |
|---|---|---|---|---|
| Material | Type | Supplier | Kg | On A + D + F |
| SU-8 Resin | Resin A | Resolution Performance Products | 46.63 | 68.5 |
| NC-3000H Resin | Resin A | Nippon Kayaku Co., Ltd. | 17.02 | 25.0 |
| Heloxy Modifier 48 | Reactive | Resolution Performance Products | 4.42 | 6.5 |
| | Monomer D | | | |
| 2-Ethoxy-8,9- | Sensitizer E | Hampford Research Products | 0.027 | 0.06 |
| dimethoxyanthracene | | | | |
| OPPI | PAG B | Hampford Research Products | 2.72 | 4.0 |
| | | Total | 70.82 | 104.04 |

A 350 liter jacketed mixing vessel constructed of 316L stainless steel and equipped with a direct drive stirrer equipped with two 3-blade propeller-type agitators was used to prepare the composition. To the mixer was charged the Reactive Monomer D and this was heated to 90-100° C. using circulating hot oil at 120° C. and mixed at 60-100 rpm. NC-3000H Resin A was added portion wise over 15 minutes while stirring at 80 rpm and maintaining the temperature at 90-100° C. The heating oil temperature was increased to 135° C. SU-8 Resin A, was next added portion wise while stirring for 80 rpm and maintaining the temperature 90-105° C. and stirred for 30 min to yield a clear melt. The temperature was then increased to 120° C. and Sensitizer E and PAG B were then added yielding a homogeneous mixture. The resulting melt was mixed slowly at 20 rpm at atmospheric pressure to allow degassing of the mixture.

### COMPARATIVE EXAMPLES

### Comparative Examples 1-4

### Dry Film Photoresist Compositions were Made by Combining the Components as Shown in Table 8

TABLE 8
Formulary of the dry film photoresist coating compositions of Comparative Examples
1-4.

| | | Comp | Comp | Comp | Comp |
|---|---|---|---|---|---|
| | | Example 1 | Example 2 | Example 3 | Example 4 |
| | | Weight, | Weight, | Weight, | Weight, |
| | | gms | gms | gms | gms |
| | | (% on | (% on | (% on | (% on |
| Material | Type | resins) | resins) | resins) | resins) |
| SU-8 Resin | Resin A | 802.5 | 250.0 | 450.0 | 2975 |
| | | (53.5) | (50.0) | (90.0) | (91.3) |
| NC-3000H Resin | Resin A | 375.0 | | — | — |
| | | (25.0) | | | |
| NER-7604 Resin | Resin A | 225.0 | 110.0 | — | — |
| | | (15.0) | (22.0) | | |
| EHPE 3150 Resin | Resin A | — | 110.0 | — | — |
| Daicel Chemical Industries, | | | (22.0) | | |
| Ltd. | | | | | |
| Tone 305 | Additive Resin C | — | — | 50.0 | — |
| | | | | (10.0) | |
| Heloxy Modifier 48 | Reactive | 75.0 | 20.0 | — | — |
| | Monomer D | (5.0) | (4.0) | | |
| Z-6040 Silane | Adhesion | 22.5 | 10.0 | — | — |
| | Promoter F | (1.5) | (2.0) | | |
| Baysilone 3739 | Surfactant H | — | 1.33 | — | — |
| | | | (0.22) | | |
| Cyracure 6974* | PAG B | — | 46.0 | 50.0 | 282.0 |
| | | | (9.2) | (10.0) | (8.66) |
| 2-Ethoxy-8,9-dimethoxy | Sensitizer E | — | — | — | — |
| anthracene | | | | | |
| Total | | 1500 | 547.33 | 550 | 2975 |

*Cyracure 6974 contains a nominal 50.0 weight % of aryl sulphonium hexafluoroantimonate salts in propylene carbonate solvent.

All components except PAG B were weighed into a tared 1 or 2 liter resin kettle. The kettle was fitted with a mechanical stirrer, a thermometer, an addition port, a vacuum port and a heating mantle. The mixture was then heated without stirring until the entire mixture had melted and the viscosity was sufficiently low to enable stirring, approximately 80° C. The mixture was then stirred at a temperature ranging from 80-100° C. for 5 to 15 minutes at approx. 30 rpm to effect complete mixing of the ingredients. The mixture was then slowly placed under reduced vacuum at 100-120° C. to remove dissolve gases and entrapped bubbles until a vacuum of approximately 10 torr had been obtained. When adequately “degassed” the vacuum was released and PAG B was then added and stirring resumed for 15 minutes to obtain a homogeneous solution. The melt mixture was then quickly placed under approximately 10 torr vacuum for 30 to 60 minutes to remove the additional dissolve gases and entrapped bubbles. When adequately “degassed” the equipment was quickly dismantled and the molten photoresist quickly poured into a suitable container.

### Preparation of Photoresist Elements

### Examples 20 and 21

### Preparation of a Photoresist Element Using a Commercial Slot Coating Machine

Dry film photoresist coating compositions prepared according Examples 7 and 8 were coated on a May Coating Technologies, St. Paul, Minn., Model DCM 150 laboratory slot coating machine using a standard slot design. The laboratory unit contained a 500 ml heated melt reservoir connected directly to a heated positive displacement pump feeding the heated slot die. The slot die is set to coat the web substrate against a hard silicone coating roll with an offset of approx 1 millimeter. The coating composition was preheated at 90° C. and the reservoir, pump and manifold were heated to 88° C. The web substrate was 9″ wide, 50 μm thick Mylar A and the cover sheet was 9″ wide, 25 μm thick Mylar A and was applied on the back side of the cooling roller, downstream from the coating roller. The thickness of the coating on the web was adjusted by varying the pumping rate of the coating composition through the slot coating head and the feed rate of the substrate film. Initial coatings were obtained at an 88° C. slot temperature, a flow rate of 8.0 cc/min and a coating speed of 10 ft/min. Raising the slot temperature to 100° C. gave better coatings at thinner thicknesses and raising the flow rate to 165 cc/min increased the coating thickness to approx 250 μm. In this manner, photoresist elements having a range of coating thicknesses as shown below in Table 9 were produced.

TABLE 9
Photoresist element using a commercial slot coating machine
according to Examples 20 and 21.

| | | Web | Flow | | |
|---|---|---|---|---|---|
| | Coating | Speed. | Rate, | Temp, | Nominal Coating |
| Example | Composition | Ft/min | cc/min | ° C. | Thickness, μm |
| 21 | 7 | 10 | 8.0 | 88 | 10 |
| 20 | 8 | 10 | 8.0 | 100 | 10 |
| 20 | 8 | 10 | 8.7 | 88 | 12 |
| 20 | 8 | 10 | 16 | 100 | 25 |
| 21 | 7 | 10 | 16.5 | 88 | 25 |
| 21 | 7 | 10 | 33 | 88 | 50 |
| 20 | 8 | 10 | 33 | 100 | 50 |
| 21 | 7 | 10 | 66 | 88 | 100 |
| 20 | 8 | 10 | 66 | 100 | 100 |
| 20 | 8 | 10 | 165 | 100 | 250 |

### Examples 22-32

### Preparation of a Photoresist Element Using a Commercial Slot Coating Machine

Dry film photoresist coating compositions prepared according Examples 10-15 were coated on a May Coating Technologies, St. Paul, Minn., Model DCM 150 laboratory slot coating machine as in Examples 20 and 21. The web substrate was 9″ wide, 50 μm thick Mylar A and the cover sheet was 9″ wide, 25 μm thick Mylar A or polyethylene as noted and was applied on the back side of a 30-35° C. heated cooling roller, downstream from the coating roller and immediately followed by a nip roller. All compositions were prefiltered by holding the mixtures at 75° C. overnight, passing the hot melt at 90° C. through a 18 μm absolute stainless steel in-line filter under nitrogen pressure, then allowing the mixtures to stand again at 75° C. overnight to degass. Each coating composition was preheated at 90° C. in an oven and the reservoir and pump were heated to 88° C. The slot head was heated to 95° C. The thickness of the coating on the web was adjusted by varying the pumping rate of the coating composition through the slot coating head from a flow rate of 6.9 cc/min to 175 cc/min and the feed rate of the substrate film from 5 ft/min to 20 ft/min. In this manner, photoresist elements having a range of coating thicknesses, substrates and coversheets as shown below in Table 10 were produced.

TABLE 10
Photoresist element using a commercial slot coating machine according to Examples
22-32.

| | Coating | Web Speed. | Flow Rate, | Nominal Coating | | |
|---|---|---|---|---|---|---|
| Example | Comp | Ft/min | cc/min | Thickness, μm | Substrate | Coversheet |
| 22 | 10 | 20 | 6.9 | 5 | PET | PET |
| 22 | 10 | 20 | 13.9 | 10 | PET | PET |
| 22 | 10 | 20 | 34.7 | 25 | PET | PET |
| 22 | 10 | 20 | 69.5 | 50 | PET | PET |
| 22 | 10 | 20 | 136 | 100 | PET | PET |
| 22 | 10 | 10 | 175 | 250 | PET | PET |
| 22 | 10 | 5 | 175 | 500 | PET | PET |
| 23 | 11 | 5 | 175 | 500 | PET | PET |
| 23 | 11 | 10 | 175 | 250 | PET | PET |
| 23 | 11 | 10 | 24.7 | 50 | PET | PET |
| 23 | 11 | 10 | 17.4 | 25 | PET | PET |
| 24 | 12 | 20 | 34.7 | 25 | PET | PET |
| 24 | 12 | 20 | 69.5 | 50 | PET | PET |
| 25 | 12 | 20 | 69.5 | 50 | Cu Foil | PET |
| 26 | 13 | 10 | 175 | 250 | PET | PET |
| 27 | 13 | 5 | 175 | 500 | PET | PET |
| 27 | 14 | 20 | 34.7 | 25 | PET | PE |
| 27 | 14 | 20 | 69.5 | 50 | PET | PE |
| 28 | 14 | 20 | 34.7 | 25 | Kapton | PE |
| 28 | 14 | 20 | 69.5 | 50 | Kapton | PE |
| 29 | 15 | 20 | 34.7 | 25 | PET | PET |
| 30 | 15 | 20 | 69.5 | 50 | PET | PE |
| 30 | 15 | 20 | 34.7 | 25 | PET | PE |
| 31 | 15 | 20 | 34.7 | 25 | Cu clad | PET |
| | | | | | Kapton film | |
| 32 | 15 | 20 | 34.7 | 25 | Kapton | PET |

PET = polyethylene terephthalate film;
PE = polyethylene film;
Kapton = polyimide film

### Prophetic Examples 10-18

### Dry Film Photoresist Coating Compositions are Made by Combining the Components as Shown in Table 10

Dry film photoresist coating compositions prepared according to Prophetic Examples 1-9 are to be coated on the same laboratory hot melt slot die coating equipment as in Examples 22-32. These compositions all gave acceptable photoresist elements as expected.

### Examples 33-35

### Preparation of a Photoresist Element Using a Commercial Slot Coating Machine

Dry film photoresist coating compositions prepared according to Examples 16-18 were coated on a May Coating Technologies, St. Paul, Minn., Model CLS 500 production scale slot coating machine with a coat hanger design die. The web substrate was 13-14″ wide, 36-50 μm thick Mylar A and the cover sheet was 13-14″ wide, 19-251 μm thick Mylar A and was applied on the back side of the 24″ hard silicone rubber coating drum, downstream from the coating location and immediately followed by a nip roller. The melt was introduced to the die by means of a 1 gal May Coating Technologies Model 10P Hot Melt Processor connected to the die inlet by means of a 6′ heated transfer line with a 401 μm in-line screen filter. Coating compositions were preheated at 85-90° C. in an oven overnight and poured into the melt processor when needed. The processor and transfer line were heated to 90° C., the slot die and the lips were heated to 95° C.-100° C. as note below. The thickness of the coating on the web was adjusted by varying the pumping rate of the coating composition through the slot coating head from a flow rate of 6.9 cc/min to 175 cc/min and the feed rate of the substrate film from a coating speed of 10 ft/min to 65 ft/min. In this manner, photoresist elements having a range of coating thicknesses, substrates and coversheets as shown below in Table 11 were produced.

TABLE 11
Preparation of a photoresist element using a commercial slot coating
machine according to Examples 33-35.

| | | Web | Flow | Nominal | Die | Lip |
|---|---|---|---|---|---|---|
| | Coating | Speed. | Rate, | Coating | Temp, | temp, |
| Example | Comp | Ft/min | cc/min | Thickness, μm | ° C. | ° C. |
| 33 | 25 | 40 | 6.9 | 25 | 95 | 95 |
| 33 | 25 | 65 | 13.9 | 50 | 95 | 100 |
| 34 | 26 | 20 | 34.7 | 25 | 95 | 100 |
| 34 | 26 | 20 | 34.7 | 25 | 100 | 100 |
| 35 | 27 | 20 | 69.5 | 50 | 100 | 105 |
| 35 | 27 | 20 | 136 | 100 | 105 | 120 |

### Comparative Photoresist Element Examples

### Comparative Examples 5-8

Dry film photoresist coating compositions prepared according to Comparative Examples 1-4 to be coated on the same laboratory hot melt slot die coating equipment as for Examples 31-41. These compositions all failed to give acceptable photoresist elements. Comparative Example 5 gave good quality films but was not photosensitive since it did not contain any photosensitive component. Comparative Example 6 and 7 both gelled before they could be coated and thus the elements were not obtained. Comparative Example 8 was coated by the process, but was brittle and showed substantial cracking and flaking.

### Lamination and Lithographic Processing of Photoresist Elements

### Example 36

### Lamination of Dry Film Photoresist to Silicon Wafer Substrates

An approximately 4 inch by 4 inch square of 501 μm thick photoresist element 31 was cut from a roll using scissors or a razor blade. The protective polyethylene cover sheet was removed in a clean room area and the dry film photoresist was placed coated side down on the surface of a 100 millimeter diameter silicon wafer substrate. The dry film photoresist was then lightly attached to the wafer by gently pressing on the PET film. Excess laminate that extends beyond the edge of the substrate was trimmed away using a razor blade or Exacto knife The wafer was then placed between two sheets of uncoated PET film to form a lamination assembly. A Dupont Riston® laminating machine was set to the desired operating parameters: air pressure 30-55 psi, top and bottom roller temperature 70-85° C., and roller speed 0.3-1.0 meters per minute. The lamination assembly was passed through the lamination machine to effect final lamination. The laminated assembly was allowed to cool in the ambient air for 2 minutes. After this time, the uncoated protective PET sheets were removed and the composite web PET layer was peeled from the substrate leaving a coating of photoresist on the substrate. All noted laminating conditions gave essentially identical results.

### Example 37

### Lithographic Imaging of Laminated Dry Film Photoresist

A 100 millimeter silicon wafer with a laminated coating of photoresist from Example 36 was exposed image-wise in vacuum contact using a variable density photolithography mask designed by MicroChem Corp on an AB-M Inc. Exposure System incorporating a 360 nm high pass light filter. The exposure dose ranged from 60 mJ/cm² to 240 mJ/cm² and was measured at 365 nm using an AB-M Inc. Intensity Meter. The exposed wafer was baked on a Brewer Science CEE hot plate at 95° C. for 3-4 minutes. Following the 95° C. bake, the imaged wafer was cooled for a minimum time of 2 minutes. The image was developed using an immersion develop process consisting of immersing the exposed wafers into a vessel containing propylene glycol monomethyl ether acetate (PGMEA) while stirring with a magnetic stirrer at 40 rpm. Typical develop times were 6-9 minutes. The developed wafers were next immersed into a second, clean PGMEA bath to remove any dissolved photoresist and then isopropyl alcohol was dispensed on the wafer to rinse off the developer. The wafer was then dried with a filtered nitrogen gas stream. This process resulted in a negative relief image of the mask on the wafer with resolution of 7 micron features.

### Example 38

### Nickel Plating

The imaged wafer from Example 37 is placed in a nickel sulfate bath and the open areas of the photoresist are nickel plate by such process using standard procedures known in the art.

### Example 39

### Lamination of Dry Film Photoresist to Silicon Wafer Substrates

An approximately 4 inch by 4 inch square of 50 μm thick photoresist element 31 was cut from a roll using scissors or a razor blade. The base substrate film was removed in a clean room area and the dry film photoresist was placed coated side down on the surface of a 100 millimeter diameter silicon wafer substrate. The dry film photoresist was then lightly attached to the wafer by gently pressing on the PET coversheet. Excess laminate that extends beyond the edge of the substrate was trimmed away using a razor blade or Exacto knife The wafer was then placed between two sheets of uncoated PET film to form a lamination assembly. A Dupont Riston® laminating machine was set to the desired operating parameters: air pressure 30-55 psi, top and bottom roller temperature 70-85° C., and roller speed 0.3-1.0 meters per minute. The lamination assembly was passed through the lamination machine to effect final lamination. The laminated assembly was allowed to cool in the ambient air for 2 minutes. After this time, the uncoated protective PET sheets were removed but the composite PET coversheet layer was left in place on the photoresist on the substrate.

### Example 40

The process of Example 39 was conducted except that the composite was laminated to an imaged substrate in a vacuum laminator wherein the composite film forms a conformal coating over the imaged substrate.

### Example 41

The process of Example 39 was conducted except that the composite was laminated to an imaged substrate in a vacuum laminator under platen pressure wherein the composite film fills all recessed areas of the substrate and then formed a planarized coating over said substrate.

### Example 42

The process of Example 39 was conducted except that the composite was laminated to an imaged substrate wherein the composite film formed a cap or cover over the raised components of the imaged substrate.

### Examples 43-46

### Lithographic Imaging of Laminated Dry Film Photoresist

Substrates laminated with a coating of photoresist from Examples 39-42 were exposed image-wise through the coversheet PET film in vacuum contact using a variable density photolithography mask designed by MicroChem Corp on an AB-M Inc. Exposure System incorporating a 360 nm high pass light filter. The exposure dose ranged from 60 mJ/cm² to 240 mJ/cm² and was measured at 365 nm using an AB-M Inc. Intensity Meter. The exposed wafers were baked on a Brewer Science CEE hot plate at 95° C. for 3-4 minutes. Following the 95° C. bake, the imaged wafer was cooled for a minimum time of 2 minutes. The images were developed using an immersion develop process consisting of immersing the exposed wafers into a vessel containing propylene glycol monomethyl ether acetate (PGMEA) while stirring with a magnetic stirrer at 40 rpm. Typical develop times were 6-9 minutes. The developed wafers were next immersed into a second, clean PGMEA bath to remove any dissolved photoresist and then isopropyl alcohol was dispensed on the wafers to rinse off the developer. The wafers were then dried with a filtered nitrogen gas stream. This process resulted in negative relief images of the mask on the wafers with resolution of 10 micron features.

### Prophetic Examples 19-25

The process of Example 39 wherein the substrate is to be composed of glass, quartz, GaAs compound semiconductor material, cured SU-8 polymer, copper foil, copper clad FR-4 composite printed circuit board, and copper clad on Kapton flexible film.

### Example 47

### Lithographic Imaging of Laminated Dry Film Photoresist

An approximately 4 inch by 4 inch square of 50 μm thick photoresist element 31 was cut from a roll using scissors. The base PET substrate film and PET coversheet layers were left in place and the thicker base substrate film was used as the substrate. The cut section of the photoresist element was exposed image-wise through the coversheet PET film in vacuum contact using a variable density photolithography mask designed by MicroChem Corp on an AB-M Inc. Exposure System incorporating a 360 nm high pass light filter. The exposure dose ranged from 60 mJ/cm² to 240 mJ/cm² and was measured at 365 nm using an AB-M Inc. Intensity Meter. After exposure the coversheet was removed. The exposed composite sheet was then baked on a Brewer Science CEE hot plate at 95° C. for 3-4 minutes. Following the 95° C. bake, the imaged composite sheet was cooled for a minimum time of 2 minutes. The image was developed using an immersion develop process consisting of immersing the exposed composite sheet into a vessel containing propylene glycol monomethyl ether acetate (PGMEA) while stirring with a magnetic stirrer at 40 rpm. Typical develop times were 6-9 minutes. The developed composite sheet were next immersed into a second, clean PGMEA bath to remove any dissolved photoresist and then isopropyl alcohol was dispensed on the wafer to rinse off the developer. The imaged composite sheet was then dried with a filtered nitrogen gas stream. This process resulted in a negative relief image of the mask on the PET composite film with resolution of 10 micron features. If desired, the cured photoresist parts could be removed from the substrate film by peeling off the PET film.

While the invention has been described above with reference to specific embodiments thereof, it is apparent that many changes, modifications, and variation can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A method of forming a photoresist element comprising the steps of:
(i) preparing a hot melt photoresist composition;
(ii) applying the photoresist composition to a film substrate using a slot die coating system;
(iii) cooling the hot melt sufficiently to prevent flow;
(iv) applying a protective cover film to the opposite surface of the partially cooled composition, thereby forming a photoresist element.

2. The method of claim 1 wherein the formed photoresist element is pressed through a warmed calendar roll to adjust or improve thickness, thickness uniformity or coating quality.

3. The method of claim 1 wherein the hot melt photoresist composition comprises:
(i) at least one polyfunctional resin (A) which can react with itself or with an added agent in the presence of a photogenerated catalyst or reactive species;
(ii) at least one thermally stable, photosensitive material (B), which initiates polymerization or structural modification of the resin (A) upon exposure to actinic radiation; and
said photoresist composition is solvent free.

4. The method of claim 3 where in the polyfunctional resin (A) is a fully or partially epoxidized polyfunctional novolac or cycloaliphatic resin.

5. The method of claim 4 where in the polyfunctional resin (A) is a fully or partially epoxidized polyfunctional novolac or cycloaliphatic resin having an epoxide equivalent weight of about 150 to 500 grams/eq.

6. The method of claim 4 wherein the novolac resin (A) is an epoxidized polyfunctional bisphenol A novolac resin having an epoxide equivalent weight of about 195 to 230 gram/eq.

7. The method of claim 4 wherein the novolac resin (A) is a fully epoxidized octafunctional bisphenol A novolac resin having an epoxide equivalent weight of about 195 to 230 gram/eq.

8. The method of claim 3 where in the polyfunctional resin (A) is an epoxidized acrylic resin or acrylated epoxy resin or mixtures of resins, t-BOC or t-butyl ester functional resins or acetal functional resins or the like.

9. The method of claim 3 wherein the photosensitive material (B) is a thermally stable photoacid or photobase generator.

10. The method of claim 9 wherein the photosensitive material (B) is a triaryl, trialkyl or mixed arylalkyl sulfonium or diaryl, dialkyl or mixed arylalkyl iodonium salt of a photoacid or photobase generator or other thermally stable PAGs or PBGs.

11. The method of claim 9 wherein the photogenerated acid is hexafluorophosphate (PF₆), hexafluoroantimonate (SbF₆), tetrakis(pentafluorophenyl)borate ([C₆F₅]₄B), or tris(trifluoromethylsulfonyl)methide acid.

12. The method of claim 3 wherein the composition contains less than 5% solvent.

13. The method of claim 3 wherein the composition additionally contains at least one non-functional or unreactive resin (C) in an amount from about 0.1% to about 70% by weight of the combined weights of components (A) and (C).

14. The method of claim 3 wherein the composition additionally contains at least one reactive monomer (D) in an amount from 0% to about 10% by weight of the combined weights of reactive components (A), (D) and (F).

15. The method of claim 3 wherein the composition contains at least one sensitizer (E) in an amount from about 0.1% to about 10% by weight of component (B).

16. The method of claim 3 wherein the composition additionally contains at least one adhesion promoter (F) in an amount from 0.1% to about 10% by weight of the combined weights of reactive components (A), (D) and (F).

17. The method of claim 3 wherein the composition additionally contains at least one light absorbing compound (G) in an amount from about 0.1% to about 10% by weight, based on the total weight of the composition.

18. The method of claim 3 wherein the composition additionally contains at least one surface leveling agent (H) in an amount from about 0.001% to about 1% by weight of the composition.

19. The method of claim 3 wherein the composition additionally contains at least one type of particulate or fibrous organic or inorganic filler in an amount from 0.1% to about 80% by weight of the composition.

20. The method of claim 19 wherein the filler consist of a nanoparticulate solid or mixture of solids with an average particle size of less than 50 nm.

21. The method of claim 1 wherein the film substrate is selected from the group consisting of a polyester film, a polyimide film, a metal foil or a composite material consisting of a metal foil bonded to a polymer film.

22. The method of claim 21 wherein the film substrate is polyethyleneterephthalate (PET) or polyethylenenaphthalate (PEN) polyester film.

23. The method of claim 21 wherein the film substrate is a copper foil, an aluminum foil, a stainless steel foil, a nickel foil, a brass foil or a tantalum foil.

24. The method of claim 21 wherein the film substrate is a copper clad polyimide (PI) or polybenzoxazole (PBO) flexible substrate.

25. The method of claim 1 wherein the film substrate contains an already coated film of the same or different coating compositions which may or may not be photosensitive and may or may not already be patterned and/or hardened which can be of different solubilities, different photosensitivities or different physical properties.

26. The method of claim 1 wherein the protective cover film is a polyester film.

27. The method of claim 1 wherein the slot die coating system is of the standard design.

28. The method of claim 1 wherein the slot die coating system is of the coathanger design.

29. A method of forming a permanent photoresist pattern, comprising the process steps of:
(i) providing a photoresist element made according to claim 1
(ii) removing the protective coating from the photoresist element, leaving the layer of photoresist attached to a film substrate;
(iii) laminating the photoresist layer to a second substrate;
(iv) removing the film substrate from the laminated layer of the photoresist on the second substrate;
(v) imagewise irradiating the photoresist layer on the coated second substrate with actinic radiation;
(vi) cross-linking or otherwise changing the solubility of the irradiated areas of the photoresist layer by heating if required;
(vii) developing an image in the photoresist layer with an aqueous base or organic solvent developing medium, thereby forming a relief image in the dry film photoresist layer; and
(viii) optionally, hardening the developed relief image by heating.

30. A method of forming a permanent photoresist pattern, comprising the process steps of:
(i) providing a photoresist element made according to claim 1
(ii) removing the polymer film substrate from the photoresist element, leaving the layer of the photoresist attached to the film substrate;
(iii) laminating the photoresist layer to a second substrate;
(iv) imagewise irradiating the photoresist layer on the coated second substrate through the protective cover sheet with actinic radiation;
(v) removing the protective coversheet from the laminated, exposed photoresist layer on the second substrate;
(vi) cross-linking or otherwise changing the solubility of the irradiated areas of the photoresist layer by heating if required;
(vii) developing an image in the dry film layer with an aqueous base or organic solvent developing medium, thereby forming a relief image in the photoresist layer; and
(viii) optionally, hardening the developed relief image by heating.

31. A cured imaged product of the dry film photoresist made according to claim 29 or 30 obtained by removal from the second substrate.

32. A method of forming a permanent photoresist pattern, comprising the process steps of:
(i) providing a photoresist element made according to claim 1
(ii) removing the protective coating from the photoresist element, leaving the layer of photoresist attached to the polymer substrate film or foil substrate;
(iii) imagewise irradiating the photoresist layer on the coated second substrate with actinic radiation;
(iv) cross-linking or otherwise changing the solubility of the irradiated areas of the photoresist layer by heating if required;
(v) developing an image in the photoresist element layer with an aqueous base or organic solvent developing medium, thereby forming a relief image in the photoresist layer;
(vi) optionally, hardening the developed relief image by heating; and
(vii) optionally, removing the cured object from the substrate film or foil.

33. A method of forming a permanent photoresist pattern, comprising the process steps of:
(i) providing a photoresist element made according to claim 1
(ii) imagewise irradiating the photoresist layer with actinic radiation through either the polymer film substrate or polymer coversheet;
(iii) removing the polymer substrate film or the protective coating from the photoresist element, leaving the layer of the photoresist attached to the remaining polymer substrate film, coversheet film or foil substrate;
(iv) cross-linking or otherwise changing the solubility of the irradiated areas of the photoresist layer by heating if required;
(v) developing an image in the photoresist layer with an aqueous base or organic solvent developing medium, thereby forming a relief image in the photoresist layer;
(vi) optionally, hardening the developed relief image by heating; and
(vii) optionally, removing the cured object from the substrate film or foil.

34. The method of claims 29, 30, 32 and 33 where photoresist layers are coated onto to both sides of the substrate film or foil and are sequentially or simultaneously imagewise irradiated.

35. The method of forming a photoresist pattern according to claims 29, 30, 32 or 33 where the actinic radiation is ultraviolet rays, X rays or electron beams.

36. The method of using a photoresist pattern according to claims 29, 30, 32 or 33 wherein:
(i) the cured object is not removed from the substrate;
(ii) relief image is used as an etch mask protecting the covered areas of the substrate while the exposed areas are being etched by an appropriate etch solution;
(iii) optionally, the relief image is stripped or otherwise removed from the selectively etched substrate.

37. The method of using a photoresist pattern according to claims 29, 30, 32 or 33 wherein:
(i) the cured object is not removed from the substrate;
(ii) the relief image is used as a plating mask allowing the exposed areas to be metalized by an appropriate metallization process;
(iii) optionally, the relief image is stripped or otherwise removed from the selectively etched substrate.

38. The method of claim 37 wherein the metallization process is electrolytic metal plating.

39. The method of claim 37 wherein the metallization process is electroless metal plating.

40. The method of claim 37 wherein the metallization process is the application of a metal containing paste.

41. The cured imaged product made according to the process of claims 29, 30, 32 or 33 when it is used in the manufacture of electronic components, micro-electromechanical system (MEMS) components, micromachine components, microfluidic components, bioMEMS components, array structures, separation and analysis platforms, cell growth platforms, micro total analysis system (μ-TAS) components, medical devices, skin patches, wearable or implantable components, micro optical or waveguide components, optical interconnects, waveguides, optical switches, optical displays, backplanes, diffuser or reflector elements or protective coatings for optical, LED or OLED components, microreactor components, electroconductive layers, lithography, galvanoforming, abforming (LIGA) components, displays, forms and stamps for microinjection molding and microembossing, screens or stencils for fine printing applications, MEMS and IC packaging components, cavities, walls/dams, cover lids, IC packaging, passivation or stress/buffer coats, die attach and no-flow underfillers, wafer level packaging, wafer bonding, chip stacking, 3-D interconnects, integrated passive devices and printed wiring boards, high density interconnects, solder masks, inner layers.
